(19) United States
(12) Patent Application Publication
(10) Pub. No.: US 2025/0110796 A1
(43) Pub. Date: Apr. 3, 2025

(54) WORKLOAD MERGING

(71) Applicant: INTERNATIONAL BUSINESS MACHINES CORPORATION, ARMONK, NY (US)

(72) Inventors: Guangya LIU, Cary, NC (US); Ying MO, BEIJING (CN); Yan Wei LI, BEIJING (CN); Yao CHEN, BEIJING (CN); Zhi LI, BEIJING (CN); Xiaoli DUAN, BEIJING (CN); Hou Fang ZHAO, BEIJING (CN)

(21) Appl. No.: 18/476,876

(22) Filed: Sep. 28, 2023

(51) Int. Cl. G06F 9/50

(52) U.S. Cl. CPC G06F 9/505; G06F 9/5072

(57) ABSTRACT

Methods, computer program products, and systems are presented. The method computer program products, and systems can include, for instance: obtaining workload characterizing data, wherein the workload characterizing data characterizes a plurality of workloads of a cluster; assessing workloads of the plurality of workloads with use of characterizing data of the workload characterizing data; generating prompting data in dependence on the assessing of the workloads of the plurality of workloads, wherein the prompting data prompts for merging of identified workloads of the plurality of workloads; and presenting the prompting data to a user.

### BACKGROUND

Embodiments herein relate to virtual machine workloads generally, and particularly to merging of virtual machine workloads.

There are a plurality of cloud based computer environment providers on the market today, each of them offering specific services with service levels, targeting specific use cases, groups of clients, vertical and geographic markets. These cloud providers compete with services of traditional IT service providers which are operated typically in on-premise environments of client owned datacenters. While cloud providers seem to have advantages over said company-owned datacenters, they are not under direct control of the client companies and there is a substantial risk of failure to provide agreed service levels. Furthermore, cloud service providers might change their service levels, prices, and service offerings more often than traditional on-premise (owned by the service consumer) information technology providers.

With the advent of cloud computing, the information technology industry has been undergoing structural changes. These changes not only affect information technology companies themselves, but also the industry in general for which information technology has become an essential part of their business operations. IT departments face the need of providing infrastructure faster, driven by their lines of business, internal clients, suppliers and external customers. On the other hand, the pressure on cost effectiveness and quality of service continues to be very high. A high level of security is of utmost importance, Cloud computer environments have to fulfill similar requirements as traditional data centers in this regard, but are perceived to provide services faster and cheaper, and to have virtually endless resources available.

With container-based virtualization, isolation between containers can occur at multiple resources, such as at the filesystem, the network stack subsystem, and one or more namespaces, but not limited thereto. Containers of a container-based virtualization system can share the same running kernel and memory space, Container based virtualization is significantly different from the traditional hypervisor based virtualization technology involving hypervisor based virtual machines (VMs) characterized by a physical computing node being emulated using a software emulation layer. Container based virtualization technology offers higher performance and less resource footprint when compared to traditional virtualization and has become an attractive way for cloud vendors to achieve higher density in the datacenter. Thus, containerization (i.e., operating a virtualized data processing environment using container-based virtualization) is changing how workloads are being provisioned on cloud infrastructure.

Data structures have been employed for improving operation of computer system. A data structure refers to an organization of data in a computer environment for improved computer system operation. Data structure types include containers, lists, stacks, queues, tables and graphs. Data structures have been employed for improved computer system operation, e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: obtaining workload characterizing data, wherein the workload characterizing data characterizes a plurality of workloads of a cluster; assessing workloads of the plurality of workloads with use of characterizing data of the workload characterizing data; generating prompting data in dependence on the assessing of the workloads of the plurality of workloads, wherein the prompting data prompts for merging of identified workloads of the plurality of workloads; and presenting the prompting data to a user.

In another aspect, a computer program product can be provided. The computer program product can include a computer readable storage medium readable by one or more processing circuit and storing instructions for execution by one or more processor for performing a method. The method can include, for example: obtaining workload characterizing data, wherein the workload characterizing data characterizes a plurality of workloads of a cluster; assessing workloads of the plurality of workloads with use of characterizing data of the workload characterizing data; generating prompting data in dependence on the assessing of the workloads of the plurality of workloads, wherein the prompting data prompts for merging of identified workloads of the plurality of workloads; and presenting the prompting data to a user.

In a further aspect, a system can be provided. The system can include, for example, a memory. In addition, the system can include one or more processor in communication with the memory. Further, the system can include program instructions executable by the one or more processor via the memory to perform a method. The method can include, for example: obtaining workload characterizing data, wherein the workload characterizing data characterizes a plurality of workloads of a cluster; assessing workloads of the plurality of workloads with use of characterizing data of the workload characterizing data; generating prompting data in dependence on the assessing of the workloads of the plurality of workloads, wherein the prompting data prompts for merging of identified workloads of the plurality of workloads; and presenting the prompting data to a user.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a computer system, enterprise systems, user equipment (UE) devices, and clients according to one embodiment;

FIG. 2A depicts a system architecture according to one embodiment;

FIG. 2B depicts a system architecture according to one embodiment;

FIG. 2C is a flowchart illustrating a method for performance by a cluster manager according to one embodiment;

FIG. 3 is a flowchart illustrating a method for performance by a cluster manager interoperating with a cluster, enterprise systems, UE devices, and clients according to one embodiment;

FIG. 4A is a chart depicting discovery processing according to one embodiment;

FIG. 4B is a chart depicting discovery processing according to one embodiment;

FIG. 4C is a chart depicting discovery processing according to one embodiment;

FIG. 4D is a chart depicting discovery processing according to one embodiment;

FIG. 4E is a relationship graph that can be produced by discovery processing according to one embodiment;

FIG. 5 depicts a user interface according to one embodiment;

FIG. 6A-6B depicts a user interface according to one embodiment;

FIG. 7 depicts a user interface according to one embodiment;

FIG. 8A-8B depicts a user interface according to one embodiment;

FIG. 9 depicts a user interface according to one embodiment;

FIG. 10 depicts a system architecture for support of merging of workload groups according to one embodiment;

FIG. 11 depicts a computing environment according to one embodiment.

### DETAILED DESCRIPTION

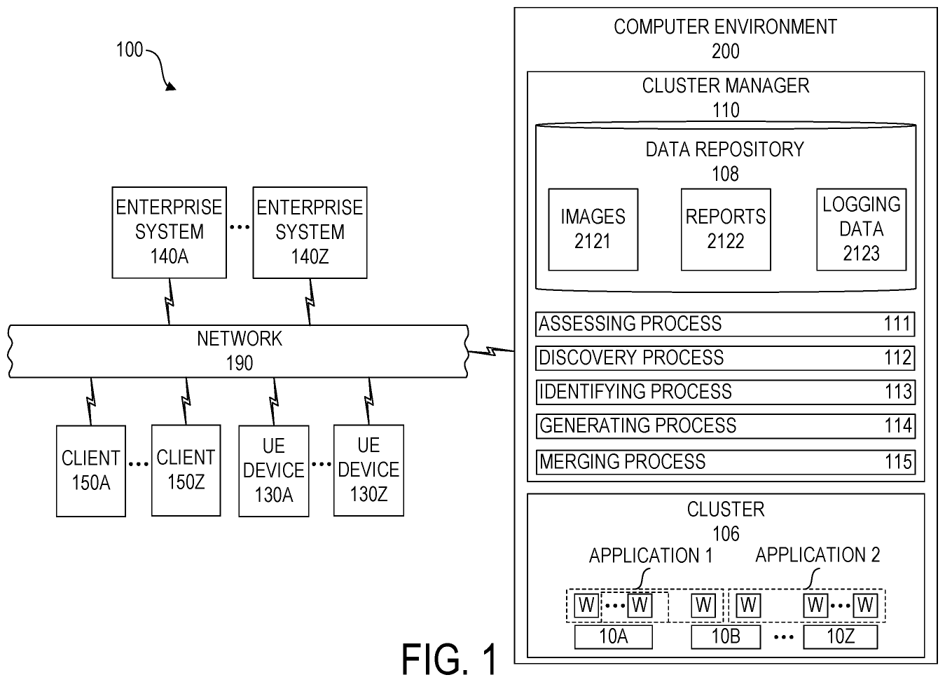

System 100 for use in improving computing resource utilization is shown in FIG. 1. System 100 can include computer environment 200, user interface (UE) devices 130A-130Z, enterprise systems 140A-140Z and clients 150A-150Z. Computer environment 200, UE devices 130A-130Z, enterprise systems 140A-140Z and clients 150A-150Z can be computing node based systems, each having one or more computing nodes. Computer environment 200, UE devices 130A-130Z, enterprise systems 140A-140Z and clients 150A-150Z can be in communication with one another via network 190. Network 190 can be a physical network and/or a virtual network. A physical network can be, for example, a physical telecommunications network connecting numerous computing nodes, such as computer servers and computer clients. A virtual network can, for example, combine numerous physical networks or parts thereof into a logical virtual network. In another example, numerous virtual networks can be defined over a single physical network.

In one embodiment, computer environment 200 can be external from each of UE devices 130A-130Z, enterprise systems 140A-140Z, and clients 150A-150Z. In one embodiment, computer environment 200 can be co-located with one or more of an instance of UE devices 130A-130Z, enterprise systems 140A-140Z and clients 150A-150Z.

Computer environment 200 can include cluster manager 110 for managing cluster 106. Cluster 106 can include a plurality of computing nodes 10A-10Z, which in one embodiment can be provided by physical computing nodes. Computing nodes 10A-10Z can host, in one embodiment, container-based workloads, W, where each computing node of computing nodes 10A-10Z hosts one or more container based workload W. Each workload, W, can include one or more container, i.e., a single container or more than one container. Where workload, W, includes more than one container, the workload containers can be closely related containers. In the context of UE devices 130A-130Z, enterprise systems 140A-140Z and clients 150A-150Z, and computing nodes 10A-10Z, “Z” can refer to an integer of any arbitrary value.

Clusters herein represented by cluster 106, according to one embodiment, can perform functions in common with clusters of a Kubernetes® container management system. For example, computing nodes 10A-10Z, according to one embodiment, can have features and functions in common with a worker node of a Kubernetes® container management system. Cluster manager 110 can have features and functions in common with a Kubernetes® master node, according to one embodiment. Kubernetes® is a trademark of the Linux Foundation. According to one embodiment, a cluster can have features in common with a Docker® Swarm™, container management system. Docker® Swarm™ is a trademark of Docker. Inc. Where computer environment 200 is a Kubernetes® environment, workloads, W, can be provided by Kubernetes®“pods” that comprise a single container or closely related containers.

Cluster manager 110 can include data repository 108 and can be configured to run various processes. Data repository 108 of cluster manager 110 can store various data.

In images area 2121, data repository 108 can store images provided by container images. Images in images area 2121 can be divided into various namespaces, wherein namespaces can be assigned on a tenant by tenant basis, wherein a first tenant can be assigned a first namespace and a second tenant can be assigned a second namespace. Container images stored in images area 2121 can be received from various enterprises associated to various different enterprise tenants which enterprise tenants are associated to different ones of enterprise systems 140A-140Z. Additionally, or alternatively, container images can be configured or designed on behalf of enterprise tenants by alternative container image development sources.

Data repository 108 in reports area 2122 can store semantic data reports that specify semantic data of container images stored in images area 2121. Semantic reports stored in 2122, in one embodiment, can be provided by markup language files, e.g., YAML files. In reports area 2122 there can also be stored text based report data specifying results of processing original reports. For example, YAML manifests associated to workloads can be processed by cluster manager 110 for production of report data, which report data can be stored in reports area 2122.

Data repository 108 in logging data area 2123 can store logging data. Logging data can record infrastructure utilization parameters returned from logging agents associated to workloads. Logging data of logging data area 2123 can include runtime logging data that specifies characteristics of container based workloads during runtime of such workloads.

Cluster manager 110 can run various processes. Cluster manager 110 running assessing process 111 can include cluster manager 110 assessing suitability of workloads, W, of cluster 106 for merging. Cluster 106 can include various workloads, W. Cluster manager 110 running assessing process 111 can discover applications defined by workload groups such as application 1 and application 2 as shown in FIG. 1 and can identify Application 1 and Application 2 as being suitable for merging when certain conditions are satisfied. Cluster manager 110 running assessing process 111 can include cluster manager 110 running discovery process 112, and also running identifying process 113.

Cluster manager 110 running discovery process 112 can include cluster manager 110 subjecting namespace associated workloads to processing for discovery of relationships between workloads and workload groups. Cluster manager 110 for discovery of workloads that are related can subject namespace associated workloads to semantic analysis and/or configuration analysis. Semantic analysis performed by cluster manager 110 can include various semantic tests and clustering analysis wherein relatedness between workloads or workload groups can be determined based on Euclidean distance thresholds. Cluster manager 110 running discovery process 112 can perform discovery processing on a namespace by namespace basis. In other words, cluster manager 110 can discover related workloads and workload groups within a first namespace and can separately discover related workload groups within a second namespace. In one aspect, cluster manager 110 performing discovery process 112 can include cluster manager performing intra-namespace processing for discovery of related workloads and applications defined by workload groups within respective namespaces of cluster 106.

Cluster manager 110 running identifying process 113 can include cluster manager 110 identifying workloads suitable for merging. Cluster manager 110 identifying workloads suitable for merging can include cluster manager 110 identifying applications defined by workload groups that are suitable for merging. Cluster manager 110 identifying workloads suitable for merging can include cluster manager 110 identifying workload groups of different namespaces that are suitable for merging. Cluster manager 110 running identifying process 113 can include cluster manager 110 comparing applications defined by workload groups that have been discovered by cluster manager 110 performing discovery process 112. Cluster manager 110 running identifying process 113 can include cluster manager 110 comparing workload groups discovered by discovery process 112 that are in different namespaces of cluster 106. Cluster manager 110 running identifying process 113 can compare applications discovered by discovery process 112 using, e.g., semantic data, configuration data, and/or runtime metrics data, which runtimes metrics data can be provided by logging data produced by logging agents of workloads running in cluster 106.

Cluster manager 110 running generating process 114 can include cluster manager 110 generating prompting data in dependence on a result of discovery process 112 and identifying process. Cluster manager 110 running generating process 114 can include cluster manager 110 generating text based prompting data. The text based prompting data generated by cluster manager 110 running generating process 114 can specify attributes of compared applications that are subject to processing by discovery process 112 and/or identifying process 113. Cluster manager 110 can be configured to present prompting data generated by generating process 114 on a user interface (UI) of a user who is associated to a UE device of UE devices 130A-130Z. A user of a UI herein can be, e.g., an administrator user and/or a developer user.

Cluster manager 110 running merging process 115 can include cluster manager 110 merging applications defined by a workload group. Cluster manager 110 running merging process 115 can include cluster manager 110 merging applications defined by a workload group in dependence on user defined data that is input to a user interface presented by cluster manager 110 responsively to prompting data presented to the user. Cluster manager 110 running merging process 115 can include cluster manager 110 removing one or more workload from at least one namespace.

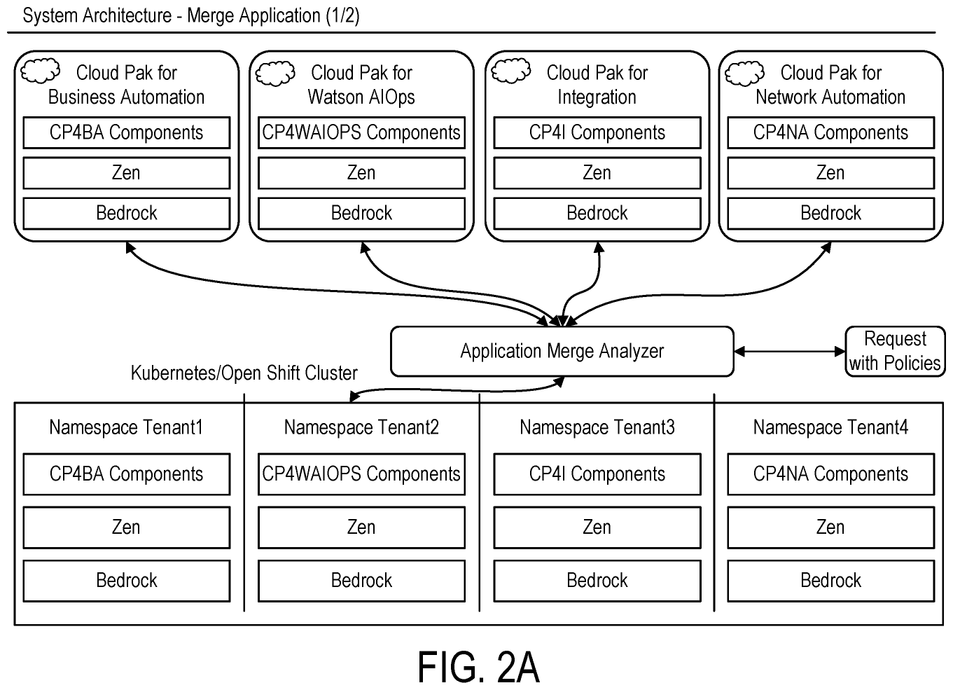

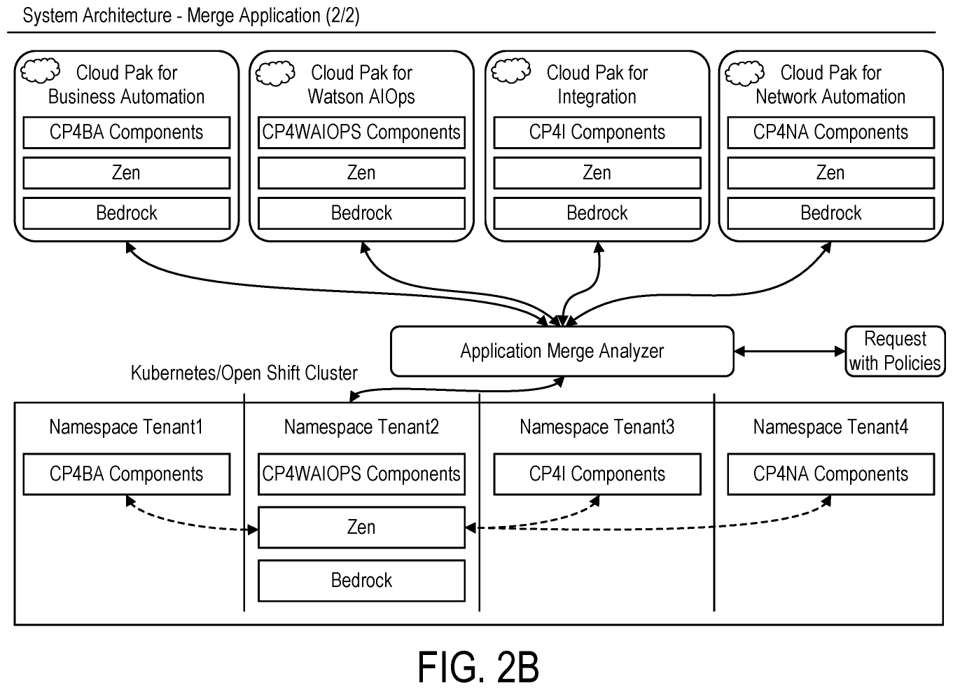

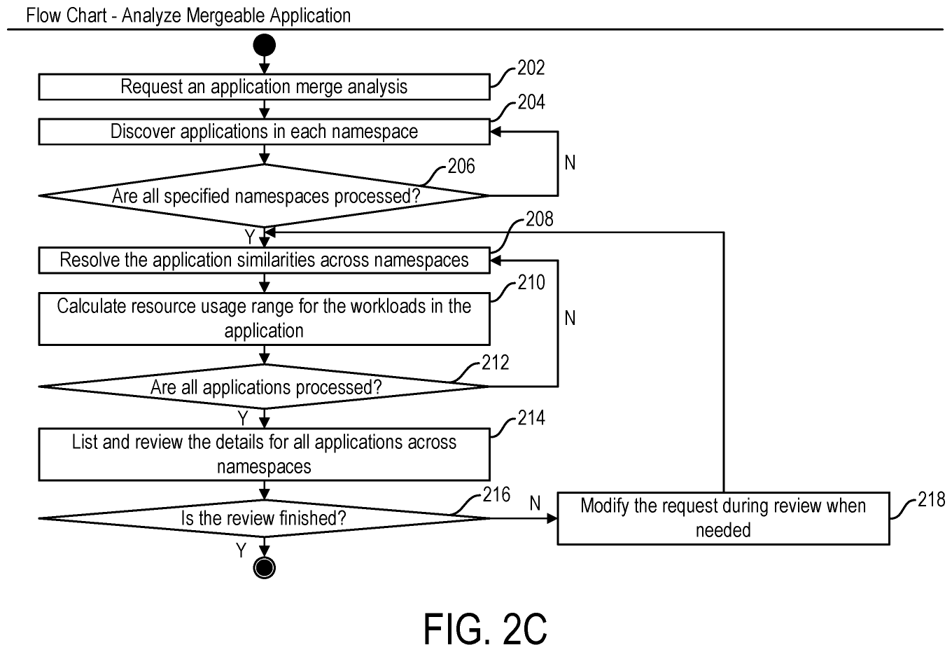

As shown in FIGS. 2A to 2B, cluster manager 110 can run an application merge analyzer defined by assessing process 111. The application merge analyzer can assess workload groups defining applications for merging. The application merge analyzer can scan different namespaces of a cluster such as cluster 106. The application merge analyzer can run discovery process 112 to discover relationships within various namespaces. The application merge analyzer can run identifying process 113 to identify, in dependence on a result of the discovery process 112, applications defined by workload groups that are suitable for merging. In reference to FIG. 2B, the application merge analyzer run by cluster manager 110 can determine that the application defined by workload group “Zen” is suitable for merging. For merging, cluster manager 110 can remove one or more instance of the workload group “Zen” (encompassing workloads of the workload group “Zen” and the workload group “Bedrock”). In the described embodiment, cluster manager 110, for performance of merging of the workload group “Zen” removes instances of the workload group “Zen” from the namespaces for tenant1, tenant3, and tenant4.

Cluster manager 110 can perform the method set forth in reference to the flowchart of FIG. 2C. At block 202, cluster manager 110 can initiate an application merge analysis. On completion of block 202, cluster manager 110 can proceed to block 204. At block 204, cluster manager 110, performing discovery process 112, can discover applications defined by workload groups in each namespace. Processing at block 204 can be performed on a namespace by namespace basis, i.e., first namespace can be processed and then a second namespace can be processed and so on. Discovery processing at block 204 can be regarded to be intra-namespace processing. Upon completion of processing of a first namespace at block 204, cluster manager 110 can proceed to block 206. At block 206, cluster manager 110 can ascertain whether all namespaces have been processed. On the determination that all namespaces have not been processed, cluster manager 110 can return to block 204 to process another namespace and cluster manager 110 can iteratively perform the loops of block 204 to 206 until all namespaces are processed by the described discovery processing. The processing of a given namespace by cluster manager 110 at block 204 can include discovery of relationships between workload groups. Workload groups herein can include one or more workload. In processing a given namespace at block 204, cluster manager 110 can begin with processing lowest order atomical workloads and can discover workloads amongst the atomical workloads that are related, e.g., by threshold satisfying Euclidean distance. The processing for determining relatedness can include, e.g., semantical and/or configuration analysis. Based on ascertaining that a first set of two or more atomical workloads are related, cluster manager 110 at block 204 can assign the first set of two or more atomical workloads to a second order workload group defining an application. Based on ascertaining that a second set of two or more atomical workloads are related, cluster manager 110 at block 204 can assign the second set of two or more atomical workloads to another (second) second order workload group defining an application. Cluster manager 110 then can search for relationships between discovered second order workload groups, e.g., using semantic and/or configuration similarity processing and can assign related second order workload groups to third order workload groups. The processing described can proceed iteratively and recursively until all workloads of a given namespace are assigned to a common top order workload group. On the determination at block 206 by cluster manager 110 that all specified namespaces of a cluster have been processed, cluster manager 110 can proceed to block 208.

At block 208, cluster manager 110 can resolve application similarities across all namespaces. At block 208, cluster manager 110 can resolve application similarities across namespaces and at block 210 can calculate resource usage range for workloads in a given application defined by a workload group to identify based on the discovery at block 204 workloads that are suitable for merging. Performing similarity analysis at block 208, cluster manager 110 can perform, e.g., semantic configuration and/or runtime metrics analysis. On completion of block 210, cluster manager 110 can proceed to block 212. At block 212, cluster manager 110, can ascertain whether all applications defined by workload groups of various namespaces have been processed. On determination that all applications defined by workload groups of all namespaces have been processed, cluster manager 110 can proceed to block 214.

At block 214, cluster manager 110 can list details of all applications across all namespaces. The listings provided generated at block 214 can define generated prompting data for prompting a user to take action in terms of initiating merging between workloads so that one or more redundant workload is removed. At block 214, cluster manager 110 can present generated prompting data. On completion of block 214, cluster manager 110 can proceed to block 216. At block 216, cluster manager 110 can ascertain whether a current merge analysis has been completed. On determination that a merge analysis has not been completed, cluster manager 110 can proceed to block 218 and can modify a merge analysis request, e.g., in response to user defined data and can return to a stage preceding block 208. Cluster manager 110 can iteratively perform the loop of blocks 208 to 218 for a time that a current merge analysis is active.

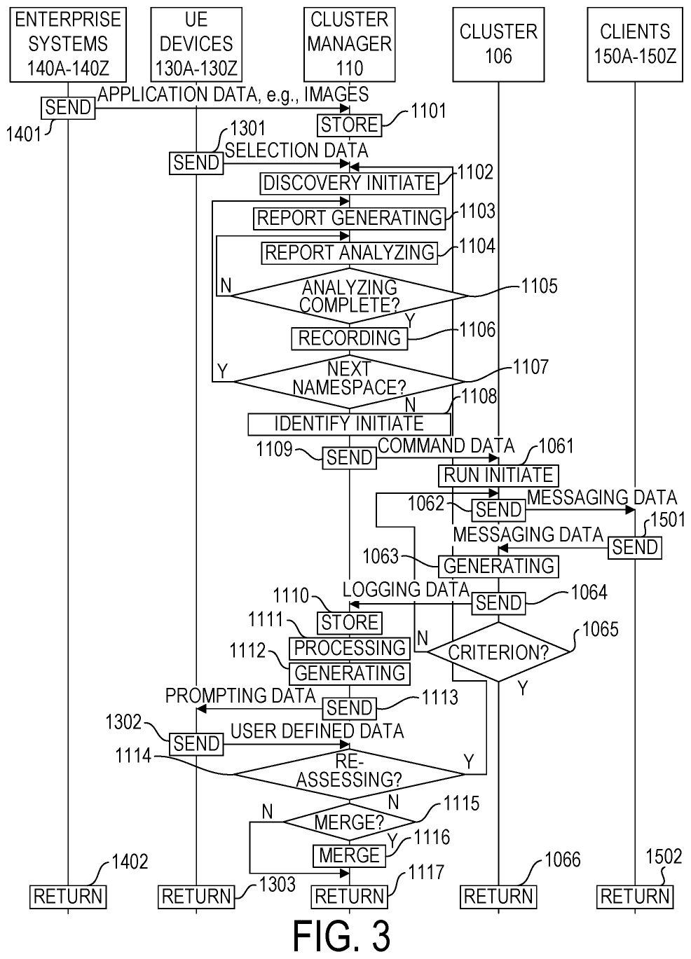

A method for performance by cluster manager 110 interoperating with enterprise systems 140A-140Z, UE devices 130A-130Z, cluster 106 and clients 150A-150Z is set forth in reference to the flowchart of FIG. 3. At block 1401, enterprise systems 140A-140Z can be sending application data, e.g., images, service level agreement (SLA requirements) and the like, to cluster manager 110 and in response to the application data, cluster manager 110 at store block 1101 can store the application data to images area 2121 of data repository 108.

At block 1301, a user using a UE device of UE devices 130A-130Z can send selection data to cluster manager 110 for initiation of running of assessing process 111 depicted in FIG. 1. In response to the selection data for initiation of assessing process 111, cluster manager 110 can proceed to discovery initiate block 1102.

At discovery initiate block 1102, cluster manager 110 can initiate discovery process 112 as set forth in FIG. 1. For performing discovery process 112, cluster manager 110 can proceed to block 1103 to perform report generating. For initiating discovery process 112, cluster manager 110 can perform report generating at block 1103. At report generating block 1103, cluster manager 110 can identify a first namespace of cluster 106 and can generate for each workload of the namespace a semantic data report, an example of which is shown in Table A. Report generating at block 1103 can include cluster manager 110 generating a text based semantic report as shown in Table A.

```
TABLE A
metadata:
  annotations:
    productID: 0bbbab06835748b9b47ea8b3c984c169
    productName: AI Manager - IBM Cloud Pak for Watson AIOps
    productVersion: 3.6.1
  labels:
    app: ibm-watson-aiops-ui
    app.kubernetes.io/component: aiops-ai-model-ui
    app.kubernetes.io/managed-by: ibm-watson-aiops-ui-operator
    app.kubernetes.io/name: aiops-aiops-ai-model-ui
    component: aiops-ai-model-ui
  name: aiops-ai-model-ui-7454d4898-vhr6c
  namespace: katamari
  ownerReferences:
  - apiVersion: apps/v1
    blockOwnerDeletion: true
    controller: true
    kind: ReplicaSet
    name: aiops-ai-model-ui-7454d4898
    uid: 4d055fd4-c5fd-4780-b4f3-ff6e75bab5d7
spec:
  imagePullSecrets:
  - name: aiops-ai-model-ui-dockercfg-jxqsr
  serviceAccount: aiops-ai-model-ui
  serviceAccountName: aiops-ai-model-ui
  volumes:
  - configMap:
      defaultMode: 420
      items:
      - key: service-ca.crt
        path: service-ca.crt
      name: aiops-ai-model-ui-tusted-cas
      optional: false
    name: trustedcas
  - name: tls-cert
    secret:
      defaultMode: 420
      items:
      - key: tls.crt
        path: tls.cert
      - key: tls.key
        path: tls.key
      secretName: aiops-ai-model-ui-tls-secret
  - name: internal-tls
    secret:
      defaultMode: 420
      items:
      - key: ca.crt
        path: ca.cert
      secretName: internal-tls
```

The report shown in Table A is a text based report provided by a YAML (yet another markup language) manifest in the YAML markup language. The report shown in Table A illustrates a YAML manifest for the workload having the name: “aiops-ai-model-ui-7454d4898”. At report generating block 1103, cluster manager 110 can generate text based reports of all workloads within a namespace.

On completion of report generating at block 1103 for a plurality of workloads in a given namespace, cluster manager 110 can proceed to report analyzing at block 1104. Report analyzing at block 1104 can include performing text based analyzing of a plurality of a text based report. The text based analyzing can include semantic analyzing and/or configuration analyzing. Semantic dimensions are dimensions in which similarity in meaning is considered (e.g., considering similarity in meaning between metadata, filenames, etc.). Configuration dimensions can be dimensions in which similarity values are applied independent of semantic meaning (e.g., assigning “1” if there is a shared image, a “zero” if there is no shared image). Report analyzing at block 1104 can include cluster manager 110 performing clustering analysis to ascertain a Euclidean distance between respective pairs of workloads within a namespace. In performing clustering analysis, cluster manager 110 can examine text based dimensions including semantic dimension and configuration dimensions as listed in Table B.

TABLE B
To calculate the distance between two workloads, below factors are
considered:
metadata.annotations, e.g.: productID, productName, productVersion.
metadata.labels, e.g.: app, component, app.kubernetes.io/ *.
metadata.name that follows certain naming pattern, e.g.: workload
name started with aiops-ai-model-ui -*
metadata.ownerReferences, e.g.: K8s resources owned by the same
operator via ownerReferences.
spec.containers[ ].image, e.g.: workloads use the same image.
spec.imagePullSecrets, e.g.: workloads use the same image pull secret.
spec.serviceAccount and spec.serviceAccountName, e.g.: workloads
use the same service account.
spec.volumes, e.g.: workloads use the same volume mount by the
configmap, secret, etc.
To determine how far two workloads are, cluster manager 110 can
check: If all above calculations show the perfect equality, then the two
workloads are closest. If only some of the above calculations
show the equality, then the more equality it has, the closer the two
workloads will be.

In performing clustering analysis across semantic dimensions, cluster manager 110 can query a trained Word2Vec predictive model for ascertaining differences between words or word groupings. By examining text based, e.g., YAML manifest reports, cluster manager 110 can ascertain semantic similarities between workloads, e.g., criterion of Table A in regard to naming similarities, and cluster manager 110 can further ascertain configuration similarity between workloads (e.g., whether workloads use a common image or volume mount, etc.). A workload group herein can comprise one or more workload. At a first iteration of block 1103 and block 1104, analyzed workload groups can comprise the atomical workloads of a namespace. For ascertaining Euclidean distance between respective workload groups, cluster manager 110 can examine linkages as set forth in Table C.

TABLE C
Single Linkage: Minimum distance between closest elements in workload groups. D(c1, c2) =
min D(x1, x2)
Complete Linkage: Maximum distance between elements in workload groups. D(c1, c2) =
max D(x1, x2)
$Average Linkage : Average of the distances of all pairs . D ( c 1 , c 2 ) = \frac{1}{\vert c 1 \vert} \frac{1}{\vert c 2 \vert} \sum \sum D ( x 1 , x 2 )$

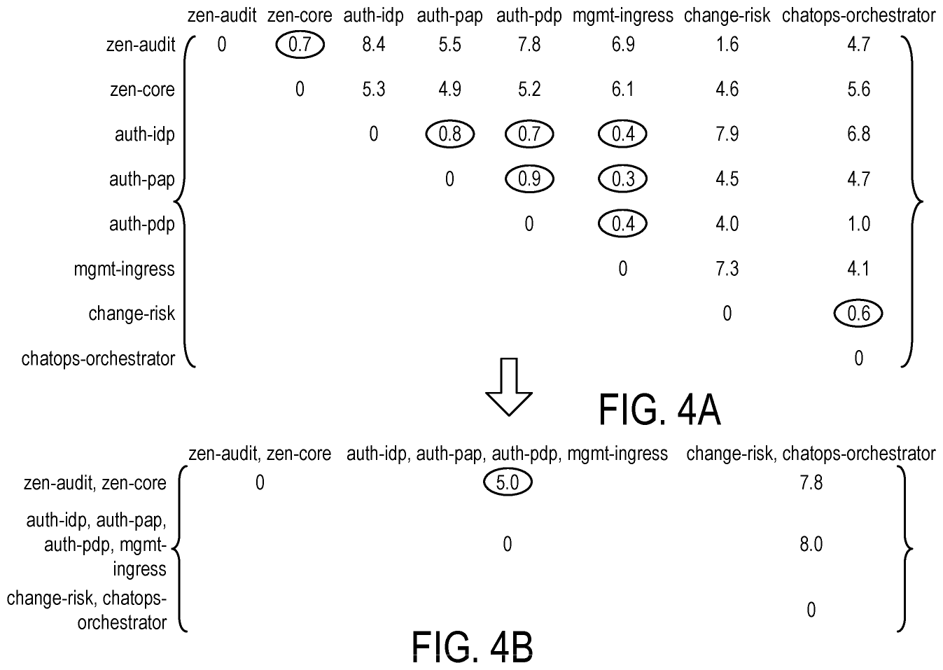

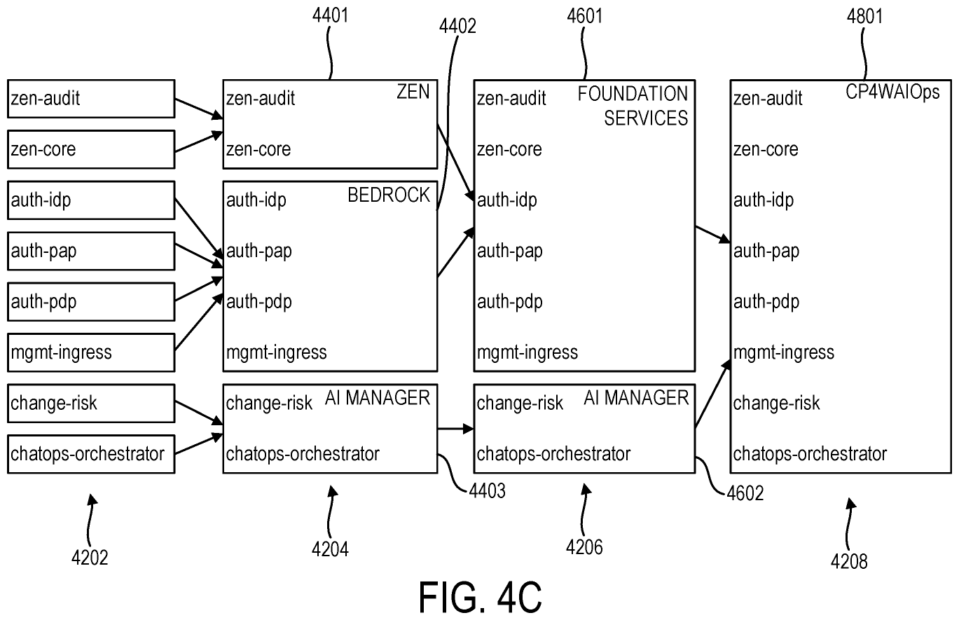

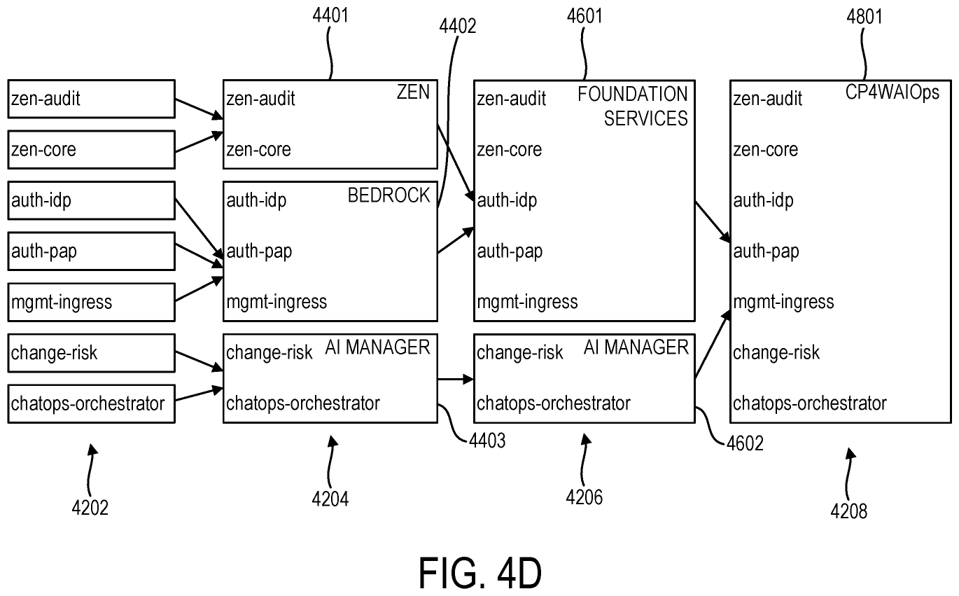

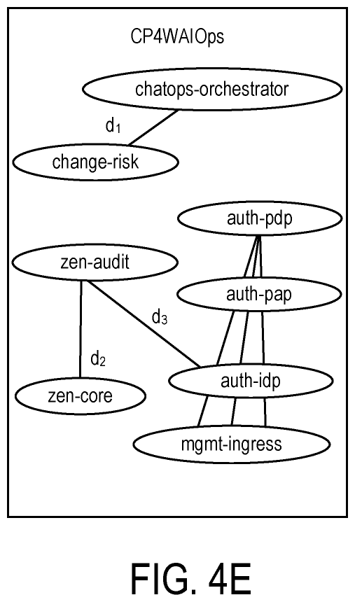

At analyzing block 1104, cluster manager 110 can identify all workloads within a namespace and can ascertain Euclidean distances between each pair of workloads within a namespace. FIG. 4A illustrates cluster manager 110 comparing Euclidean distances between atomical workloads for identification of related workloads that define second order workload groups. The atomical workloads can be regarded to be first order workgroups. For discovery of second order workload groups, cluster manager 110 can discover atomical workloads that are related. Related workloads defining workload groups can be workloads within a threshold satisfying Euclidean distance of one another. In reference to FIG. 4A, cluster manager 110 can determine that the circled pairs of the workloads define second order workload groups based on the pairs of workloads satisfying a threshold Euclidean distance.

With second workload groups as indicated with the circled pairs of FIG. 4A discovered at block 1104, cluster manager 110 as part of performing analyzing at block 1104 can proceed to block 1105 to ascertain whether analysis of a current namespace within a cluster has been completed. In one embodiment, analysis of a current namespace can be determined to be complete when all workloads of a namespace have been grouped in a top order workload group.

On the determination at block 1105 that analysis of a current namespace has not been complete, cluster manager 110 can return to analyzing at block 1104 using an output from a preceding iteration of block 1104. At a second iteration of analyzing block 1104 in the described example, cluster manager 110 can perform processing as set forth in FIG. 4B. For performing processing as set forth in FIG. 4B, cluster manager 110 can ascertain Euclidean distance between second order workload groups identified by the method described in reference to FIG. 4A. In FIG. 4B, determined Euclidean distances between second order workload groups are plotted. Cluster manager 110 can ascertain that second workload groups that are within a threshold satisfying Euclidean distance of one another define third order workload groups. In the described example, the circled workload groups depicted in FIG. 4B can be ascertained to be a third order workload group.

FIGS. 4A and 4B illustrate an iteratively recursive process performed at analyzing block 1104. Cluster manager 110 can iteratively and recursively identify progressively higher order workload groups by the process depicted in FIGS. 4A and 4B until all workloads within a given namespace are grouped within a highest (top) ordered workload group for a namespace. The iterative recursive stages are represented by iterations of block 1104 in FIG. 3. Discovery processing herein as set forth in reference to analyzing block 1104 can proceed on a bottom up basis, wherein there is initially a discovering of first order workload groups defined by atomical workloads, then proceeding to discovering second order workloads, and progressively higher order workloads until a top order application defined by a workload group is discovered.

Outputs at the described iteratively recursive stages at block 1104 are illustrated in FIG. 4C. In column 4202 there are depicted atomical workloads within a namespace of a cluster 106. The atomical workloads of column 4202 define first order workload groups. Each atomical workload of column 4202 can include one or more container. Each atomical workload can be provided by a Kubernetes®“pod” where computer environment 200 is a Kubernetes® cluster based computer environment. In column 4204, there are depicted second order workload groups of closely related containers identified by the thresholding process depicted in FIG. 4A. In column 4204, there is depicted workload group 4401, workload group 4402, and workload group 4403. In column 4206, there are depicted third order workload groups of closely related containers identified by the thresholding process depicted in FIG. 4B.

In column 4206, there is depicted workload group 4601, and workload group 4602, In column 4208, there is a single workload group 4801 having all workloads of a given namespace. Based on the processing depicted in FIGS. 4A-4D, cluster manager 110 can construct a relationship graph as depicted in FIG. 4E.

Analyzing at block 1104 can consist of static text based processing, and can be absent of dynamic runtime analysis. When via iterations of block 1104, cluster manager 110 groups all workloads within a namespace into a single workload group, e.g., workload group 4801 depicted in FIG. 4D, cluster manager 110 can proceed to recording block 1106. At recording block 1106, cluster manager 110 can store into reports area 2122 of data repository 108 the products of the iterations of the analyzing at blocks 1104, including the information of the identified workload groups depicted in FIG. 4C and FIG. 4D, and the relationship graph of FIG. 4E.

On completion of recording at block 1106, cluster manager 110 can proceed to block 1107. At block 1107, cluster manager 110 can ascertain whether there is a next namespace to be analyzed within a current cluster such as cluster 106 (FIG. 1). Embodiments herein recognize that a cluster manager 110 can assign different workloads within cluster 106 different namespaces, e.g., for logical separation between tenants. That is, cluster manager 110 can assign a first enterprise tenant a first namespace and can assign a second enterprise tenant a second namespace.

For a time that there are remaining namespaces within a cluster, cluster manager 110 can return to perform the loop of blocks 1103 to 1105 and generate for each new namespace identified within a cluster, workload associated text based reports as shown in Table A, workload group identification as illustrated in FIGS. 4A through 4C, and workflow graph outputting as shown in FIG. 4E.

It is seen that when performing iterations of processing at analyzing block 1104, cluster manager 110 can produce differentiated results depending on the namespace that is being analyzed. For example, where cluster manager 110 analyzes a second namespace for a second tenant (the namespace associated to FIG. 4C being a first namespace associated to a first tenant), cluster manager 110 can produce result data as illustrated in FIG. 4D. In FIG. 4D, discovered workload groups for a second namespace are similar to discovered workload groups for the first namespace (FIG. 4C) but there are differences. Namely, the workload “auth-pdp” is missing from workload groups 4801, 4601, 4402. In a subsequent identifying stage according to identifying process 113 dependent on discovery process 112 defined by iterations of block 1104, differences between workload groups can be specified in output data that can define prompting data.

On completion of analysis at block 1104 and recording at block 1106 for last namespace of a cluster, and determining at block 1107 that there are no further namespaces to subject to discovery processing by discovery process 112, cluster manager 110 can proceed to block 1108. There is set forth herein, in one embodiment, obtaining workload characterizing data, wherein the workload characterizing data characterizes a plurality of workloads of a cluster; assessing workloads of the plurality of workloads with use of characterizing data of the workload characterizing data; generating prompting data in dependence on the assessing of the workloads of the plurality of workloads, wherein the prompting data prompts for merging of identified workloads of the plurality of workloads; and presenting the prompting data to a user. In one example, the workload characterizing data can include, e.g., text based data as described in reference to Table A. In another aspect, as set forth herein in reference to block 1064, the workload characterizing data can include, e.g., runtime performance metrics data provided by logging data. In one example, the text based data can facilitate static analyzing of workloads, and the runtime metrics data can facilitate dynamic runtime analyzing of workloads.

At block 1108, cluster manager 110 can initiate identifying of workloads suitable for merging according to identifying process 113. In identifying workloads suitable for merging, cluster manager 110 can utilize characterizing data output from discovery processing as set forth in reference to blocks 1102 to 1107 and/or can utilize runtime metrics data.

In analyzing workloads for similarities and identifying workloads suitable for merging, cluster manager 110 can compare workload groups of a first namespace to workload groups of a second namespace with use of a hierarchical ordering of workload groups output by cluster manager 110 during performance of discovery process 112 defined by blocks 1102-1107. By performing comparisons between namespaces on a workload group to workload group basis using a hierarchical ordering of workload groups recorded for respective namespaces at block 1106, cluster manager 110 can maximize a number of workloads that can be merged by a merging, and can reduce processing resource consumption for identification of workloads suitable for merging. For example, where a comparison of a higher order (second order or above) workload group to a corresponding higher order (second order or above) workload group results in determination that the workload groups can be merged, the merging can result in removal of each workload within one of the workload groups (determined to be redundant by the identification processing). In comparing namespaces for identification of workloads suitable for merging, cluster manager 110 can proceed on a top down basis, in contrast to discovery processing herein which can proceed on a bottom up basis. For example, in reference to the namespaces referenced in FIGS. 4C and 4D, cluster manager 110 can initially compare the top order discovered workload groups 4801, and then can proceed to the third order workload groups 4601 and 4602, and so on. The processing using the hierarchical ordering of workload groups output by discovering processing maximizes a number of workloads that can be removed during a merge, and, by the organized and ordered identification reduces processing resources consumed in the identifying of workloads suitable for merging. When cluster manager 110 identifies workload groups suitable for merging, cluster manager 110 has identified the workloads within the respective workload groups suitable for merging.

For performance of identifying process 113, cluster manager 110 can perform blocks 1108-1111 according to one embodiment. On completion of initiate block 1108, cluster manager 110 can proceed to send block 1109. At send block 1109, cluster manager 110 can send command data to initiate running of all workloads of a cluster. Responsively, cluster 106 can initiate running of all workloads. To the extent workloads of cluster 106 are previously running, blocks 1108 and 1061 can be avoided. At send block 1109, cluster manager 110 can send command data to cluster 106 to initiate running of workloads on cluster 106. In response to the command data sent at block 1109, cluster 106 can initiate running of workloads on cluster at block 1061. With the running of workloads at block 1061, cluster 106 at send block 1062 can send messaging data defining traffic to clients 150A-150Z and clients 150A-150Z can responsively send messaging data defining traffic to cluster 106. Where workloads operate independent of end user traffic, blocks 1062 and 1501 can be avoided and workload agents can generate logging data independent of end user traffic.

In response to the received messaging data sent at block 1501, cluster 106 can proceed to 1063 to perform generating of logging data. Logging data can be generated by logging agents of cluster workloads at cluster 106. Logging data generated at generating block 1063 can include performance metrics data such as data in respect to, e.g., CPU utilization, working memory utilization, storage memory utilization, and/or input/output (I/O) utilization.

In response to the generating at block 1063, cluster 106 can proceed to block 1064. At block 1064, cluster 106 can send generated logging data generated at block 1063. Sending logging data at block 1064 can include sending logging data for receipt by cluster manager 110. On completion of send block 1064, cluster 106 can proceed to criterion block 1065. At criterion block 1065, cluster 106 can ascertain whether a criterion for ceasing sending of logging data has been satisfied. One criterion can be that workloads of cluster 106 have been stopped. For a time that criterion for terminating sending of logging data has not been terminated, cluster 106 can iteratively perform the loop of blocks 1062 to 1065 to send next iterations of logging data. On receipt of logging data iteratively sent at block 1064, cluster manager 110 at store block 1110 can store the received logging data. On determination that sufficient logging data defining runtime metrics data has been accumulated for cluster 106, cluster manager 110 can proceed to processing block 1111.

At processing block 1111, cluster manager 110 can perform similarity processing to compare workload groups of different namespaces for similarity that have been subject to characterizing by the discovery processing of blocks 1102 to 1107. In some aspects, similarity processing can be static analysis based and independent of runtime performance metrics. In some aspects, similarity processing can be dependent on runtime performance metrics. Similarity processing to compare workload groups of different namespaces can include one or more of static analysis or dynamic runtime analysis. An example of similarity analysis to identify workload groups of different namespaces that are similar and suitable for merging is set fort in reference to Table F herein. Similarity analysis to identify workload groups of different namespaces tat are similar and suitable for merging can be performed in dependence on or independent of runtime analysis of workload groups and/or workloads.

At processing block 1111, cluster manager 110 can perform runtime analysis of workload groups and workloads within namespaces of the cluster, e.g., cluster 106. In some embodiments, the runtime analysis of workload groups and workloads can inform the identification workload groups and workloads that are suitable for merging. Additionally, or alternatively, the runtime analysis of workload groups and workloads can inform the generation of prompting data that prompts a user in allocating provisioning resources to workload groups and workloads to be merged. Cluster manager 110 performing runtime analysis of workloads can perform runtime analysis between workload groups in a manner described in reference to Table D. For runtime analysis at processing block 1111, cluster manager 110 can process logging data to compare runtime performance metrics logging data of a first application defined by a workload group of a first namespace to a second application of second namespace defined by a workload group of the second namespace as discovered by the discovering process of blocks 1102 to 1107.

TABLE D
The formula to calculate CPU and working memory usage for a container of one workload in a
namespace within 1h:

| | |
|---|---|
| Max CPU usage: | 100 * |

max(rate(container_cpu_usage_seconds_total{namespace=″<namespace>”}[1h])) by(container,
workload, namespace)

| | |
|---|---|
| Min CPU usage: | 100 * min(rate(container_cpu_usage_seconds_total{namespace=″ |

<namespace>”}[1h])) by(container, workload, namespace)

| | |
|---|---|
| Max Memory usage: | max(max_over_time(container_memory_usage_bytes{namespace=″ |

<namespace>″}[1h])) by(container, workload, namespace)

| | |
|---|---|
| Min Memory usage: | min(min_over_time(container_memory_usage_bytes{namespace=″ |

<namespace>″}[1h])) by(container, workload, namespace). User can review and adjust the replicas
in the Application resource to trigger the updates of suggested values.

Cluster manager 110 performing similarity analysis between namespaces is described with reference to Table E.

TABLE E
$S = \frac{1}{n} {\sum }_{1}^{n} sp$
Where S is the similarity between workload groups of first and second namespaces, n is the num-
ber of workloads inside the workload group, and sp is the similarity of the two workloads
between two namespaces, 0 ≤ sp ≤ 1, if the workload does not exist in one namespace, sp is 0.
And
$sp = \frac{1}{m} {\sum }_{1}^{m} sd$
Wherein m is the number of dimensions to calculate the similarity between the two workloads, and
sd is the similarity of the workload dimensions.

Cluster manager 110 in comparing namespaces with use of the formulae of Table D can analyze workload groups on a workload group by workload group basis. In one example, FIG. 4D illustrates workload groupings of a second namespace and FIG. 4C illustrates workload groupings of a first namespace. Cluster manager 110 in performing similarity analysis between namespace can initially compare highest order (top order) workload groups between the namespaces (the workload groups of columns 4208), then can move to comparing workload groups of the next highest order (the workload groups of columns 4206), then can move to comparing the workload groups of the next highest order (the workload groups of columns 4204), then can move to comparing the workload groups of the next highest order (the atomical workloads workload groups of columns 4202). The described “top down” processing (starting with the highest order groups) assures that when a matching condition is identified, a maximum number of determined redundant workloads can be removed by a merging, and reduces computing resource consumption associated with identification of workloads suitable for merging.

In performing similarity analysis between workloads of different namespaces, cluster manager 110 can apply static analysis criterion as are listed in Table F.

TABLE F
There are many reasons that some application is not 100% similar, e.g.: If two workloads use different
configmap or secret, then s_{d} is 0; if they use the same configmap or secret but with different contents,
then s_{d} is 0.5, otherwise s_{d} is 1, or s_{d} can be scaled in dependence on Euclidean distance in semantic
meaning of the different contents. If two workloads use different images, then s_{d} is 0; if they use the
same image but with different digests or tags, then s_{d} is 0.5, otherwise s_{d} is 1, or s_{d} can be scaled in
dependence on Euclidean distance in semantic meaning of the digests or tags. Some configuration
defined in Custom Resource may determine which modules are enabled/disabled. The application in
different namespaces may have different configuration with different running workloads. To calculate
this:
$sd = \frac{2 p 12}{p 1 + p 2}$
Where p1 is the workload number for the application in one namespace, where p2 is the workload
number for the application in another namespace, and where p12 is the workload number for the
application in two namespaces.

The static analysis set forth in Table F can be performed with use of processing of text based workload characterizing data, e.g., the recorded text based, e.g., YAML manifest reports recorded at block 1106. The analysis set forth in Table F can feature semantic (meaning based) processing of text based report data, and/or can feature configuration based (independent of semantic meaning) processing of text based report data. For return of Euclidean distances between words, cluster manager 110 can query a trained word2vec predictive model as set forth herein.

In addition to or in place of the static analysis criterion listed in Table F, cluster manager 110 can use a result of the runtime processing referenced in Table D for ascertaining similarities between workload groups and workloads. According to one policy, for example, cluster manager 110 can qualify workload groups between different namespaces as being similar based on having runtime CPU and/or memory utilization characteristics satisfying a threshold level of similarity or dissimilarity. In one embodiment, inter-namespace workload group similarity analyses by cluster manager 110 can be performed independent of runtime metrics data summarized in Table D. In one embodiment, inter-namespace workload group similarity analyses by cluster manager 110 can be performed independent of static analysis.

Cluster manager 110 in comparing namespaces with use of the formulae of Table D can analyze workload groups on the workload group by workload group basis with use of characterizing data output by discovery processing herein, including hierarchical ordering of workgroups as set forth herein. In one example, FIG. 4D illustrates workload groupings of a second namespace and FIG. 4C illustrates workload groupings of a first namespace. Cluster manager 110 in performing comparison analysis between namespaces can initially compare highest order workload groups between the namespaces (the workload groups of columns 4208), then can move to comparing workload groups of the next highest order (the workload groups of columns 4206), then can move to comparing the workload groups of the next highest order (the workload groups of columns 4204), then can move to comparing the workload groups of the next highest order (the atomical workload groups of columns 4202). The described “top down” processing (starting with the top order workload groups) assures that when a matching condition is identified, a maximum number of determined redundant workloads can be removed by a merging, and reduces computing resource consumption associated to identifying workloads suitable for merging. For facilitating comparisons between workload groups comprising multiple workloads, cluster manager 110 can aggregate the per-workload utilization metrics summarized in Table D.

At processing block 1111 in some embodiments, cluster manager 110 can disqualify inter namespace workloads from merging based on runtime metrics data of the compared workloads. According to one example policy, cluster manager 110 can qualify workload groups for merging (and therefore their associated workloads) based on the workload groups featuring a threshold level of imbalance between CPU and/or memory utilization. For example, cluster manager 110 can qualify merging based on utilization of a first workload group of a first namespace being at least 85% greater than a second workload group of a second namespace. Under this described policy, elimination of under-utilized workloads may be prioritized.

According to one example policy, cluster manager 110 can qualify workload groups for merging based on the workloads featuring a threshold level of balance between CPU and/or memory utilization. For example, cluster manager 110 can qualify merging based on utilization of a first workload group of a first namespace being within 60% of a second workload group of a second namespace. Under this described policy, impact to the end user might be prioritized.

In analyzing runtime metrics, cluster manager 110 can compare workload groups of a first namespace to workload groups of a second namespace. For performing identification of workloads suitable for merging, cluster manager 110 can analyze workload groups for similarities. For performing identification of workloads suitable for merging in one example, cluster manager 110 can perform analyzing of runtime metrics data for filtering out workload groups that are not suitable for merging.

On completion of processing at block 1111, cluster manager 110 can proceed to generating block 1112. At generating block 1112, cluster manager 110 can generate prompting data that prompts a user to initiate merging of workloads. In one embodiment, text based UI presented data that specifies that there is a significant level of similarity between workload groups can define prompting data that prompts for merger between workload groups and their associated common workloads. The significant level, in one embodiment, can be the similarity level of 50 percent or more. The generating at block 1112 can be dependent on the processing at block 1111. UI presented data defining prompting data for prompting merging between workloads can take on other forms. For example, presented UI data that highlights names of first and second workload groups can define prompting data for prompting merger of the workload groups.

On completion of generating block 1112, cluster manager 110 can proceed to presenting the prompting data by sending the prompting data. At block 1113, cluster manager 110 for presenting the prompting data can send the prompting data generated at block 1112 to a user interface of a UE device of a user.

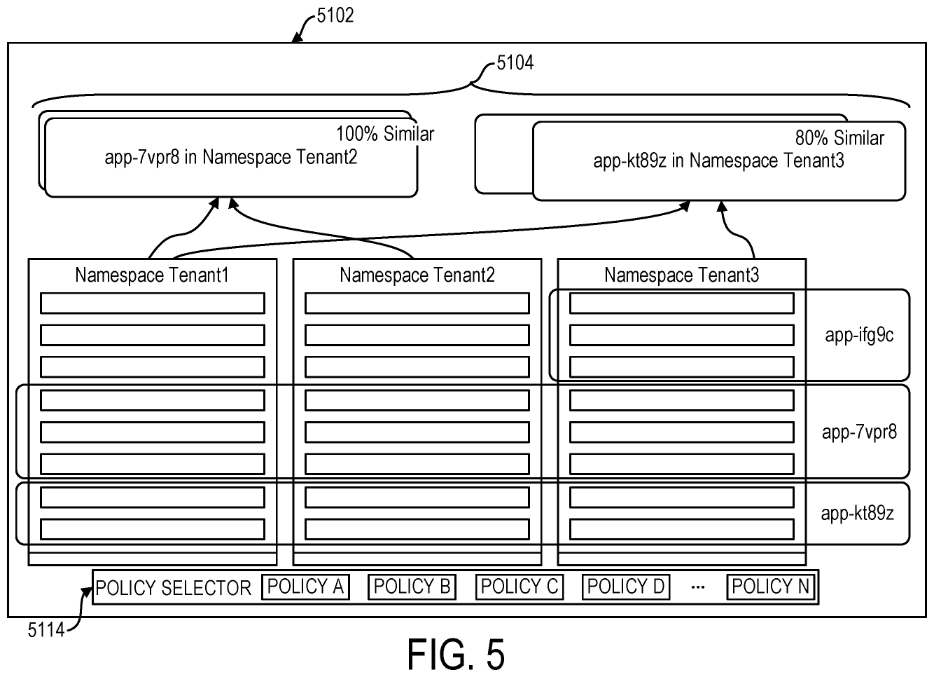

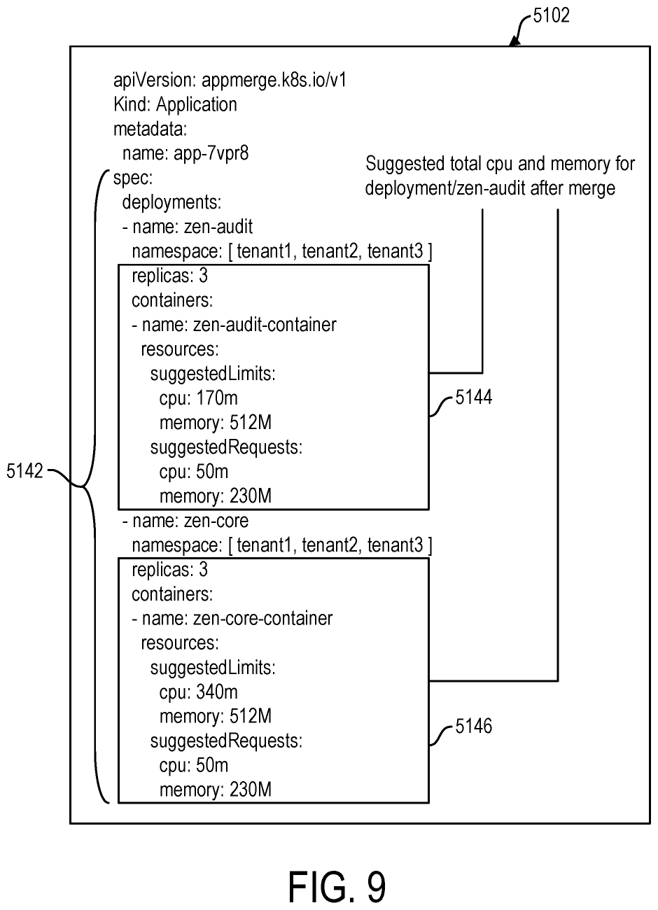

An example of presented prompting data is shown in FIG. 5. FIG. 5 illustrates a displayed user interface (UI) 5102 for display on a UE device of a user, such as a UE device of UE devices 130A-130Z. Prompting data 5104 of UI 5102 prompts a user to initiate merging of various workload groups. In response to presented prompting data, a user can enter into UI 5102 user defined input data for initiating merging of the workload groups for which merging is prompting. The user defined input data can include, e.g., appropriate edits to source code to resolve semantical conflicts between software files defining workloads groups, and/or input data to confirm that such appropriate edits have been reviewed and approved. The user defined input data can include, e.g., input data to assign appropriate resourcing to merged workloads as may be prompted for in a manner set forth in reference to Table H and FIG. 9.

When inputs are entered into UI 5120 to initiate merging of workload groups, cluster manager 110 can train a machine learning predictive model with training data that comprises an edit log of the edits, and, in later iterations, when cluster manager 110 is supporting merge analysis requests associated to the same or different user, cluster manager 110 can query the predictive model at generating block 1112 to generate for presentment specific prompting data that prompts for specific software code edits associated to respective prompted for merges.

Referring to prompting data 5104 presented on UI 5102, prompting data 5104 presents summary data indicating similar workloads between different namespaces associated to different tenants. Prompting data 5104 presented on UI 5102 specifies that the first order (lowest order) workload group app-kt89z is 80% similar between the namespaces for tenant1 and tenant2. Prompting data 5104 further specifies that the workload group-app-7vpr8 is 100% similar between the different namespaces for tenant1 and tenant2. Thus, prompting data 5104 prompts for the merging of the specified workload groups app-kt89z and app-7vpr8.

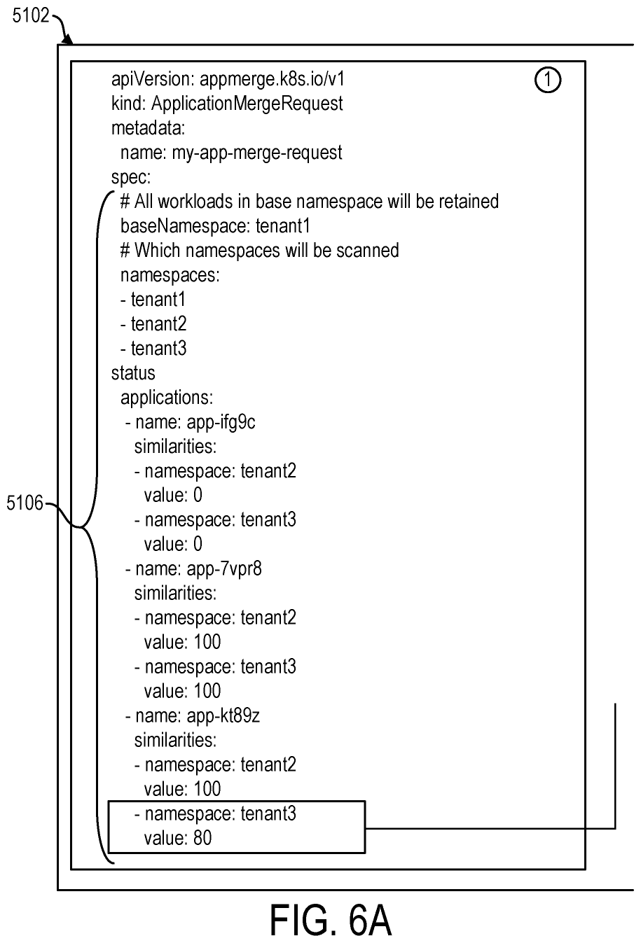

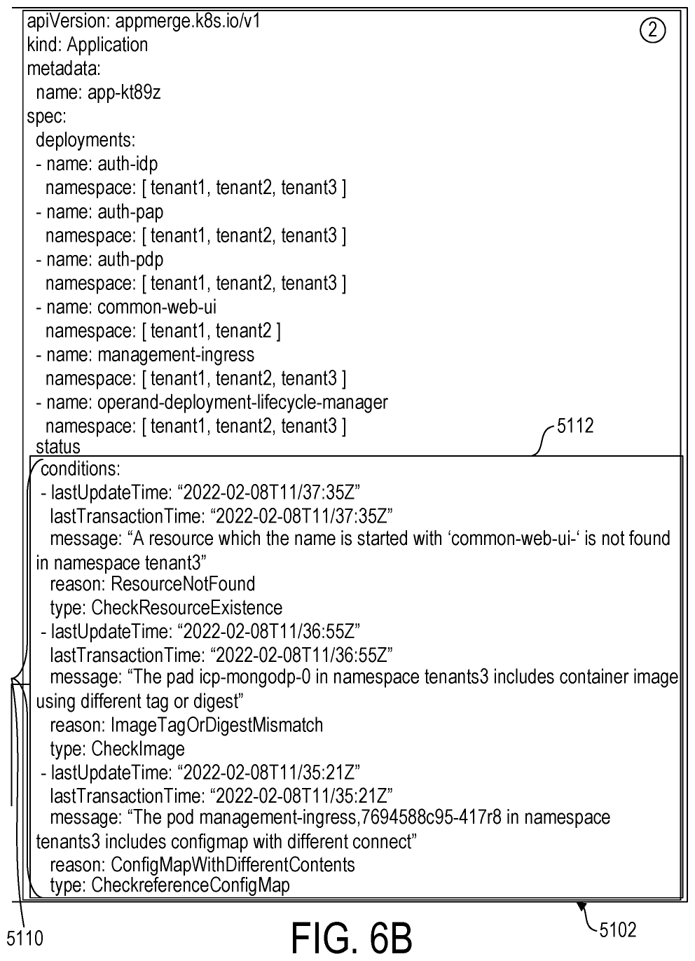

Prompting data for prompting action on the part of a user can take on alternate forms. In FIGS. 6A-6B, prompting data 5106 presented on UI 5102 specifies similarity level of the workload groups app-ifg9c, app-7vpr8, app-kt89z, between the namespaces of tenant1 and tenant2, and tenant3. Prompting data 5106 specifies that the workload group app-ifg9c is 0 percent similar between the namespaces of tenant1 and tenant2 and 0 percent similar between the tenant1 and tenant3 namespaces. Prompting data 5106 specifies that the workload group app-7vpr8 is 100 percent similar between the namespaces of tenant1 and tenant2 and 100 percent similar between the tenant1 and tenant3 namespaces. Prompting data 5106 specifies that the workload group app-kt89z is 100 percent similar between the namespaces of tenant1 and tenant2 and 80 percent similar between the tenant1 and tenant3 namespaces. Thus, prompting data 5106 prompts for the merging of the workload group app-7vpr8 and the workload group app-kt89z.

Prompting data for prompting action of a user can specify attributes of extracted differences between workloads as extracted by the processing at block 1111. In reference to FIG. 6B, prompting data 5110 within border 5112 specifies attributes of differences between the workload group named group app-kt89z specified as being 80 percent similar between the different workload group instances of the commonly named workload groups in the tenant1 and tenant3 namespaces (FIG. 6B). Thus, with the prompting data 5110, a user is prompted to address such differences when initiating merging of the workload group instances of application work group app-kt89z between the tenant1 and tenant3 namespaces. The addressing can include, e.g., editing code to remove semantical differences, reconfiguring resources so that differences are removed, etc.

As shown in FIG. 5, UI 5102 can include a policy selector area 5114 that permits a user to select a policy employed by cluster manager 110 in determining similarities between workload groups across different namespaces. The determined level of similarity between workload groups determined by cluster manager 110 can be dependent on which policy is active. Policy selector area 5114 can be presented within any view of UI 5102 set forth throughout the drawings.

Similarity processing policies that can be selected with use of policy selector area 5114 are specified in Table G.

TABLE G

| Policy | Description |
|---|---|
| POLICY A: | The missing workloads will be ignored |
| IgnoreMissing Workloads | when resolving the application similarity. |
| POLICY B: | Always use the more recent image tag if |
| UserecentImageTag | finding an old tag used when resolving the |
| | application similarity. |
| POLICY C: | The ConfigMap content difference will be |
| IgnoreConfigMapContent | ignored when resolving the application |
| | similarity. |
| POLICY D: | The StatefulSet will be ignored when |
| IgnoreStatefuleSets | resolving the application similarity. |
| . . . | . . . |
| POLICY N | XXXX |

In one use case, a user can specify that all of the policies of Table F are active simultaneously. In one use case, a user can specify that all of the policies of Table F are active sequentially, so that different similarity levels may be determined between workload groups at different times. In one use case, a user can specify that none of the policies are active. In one use case, a user can specify that only one, two, or three of the policies are active.

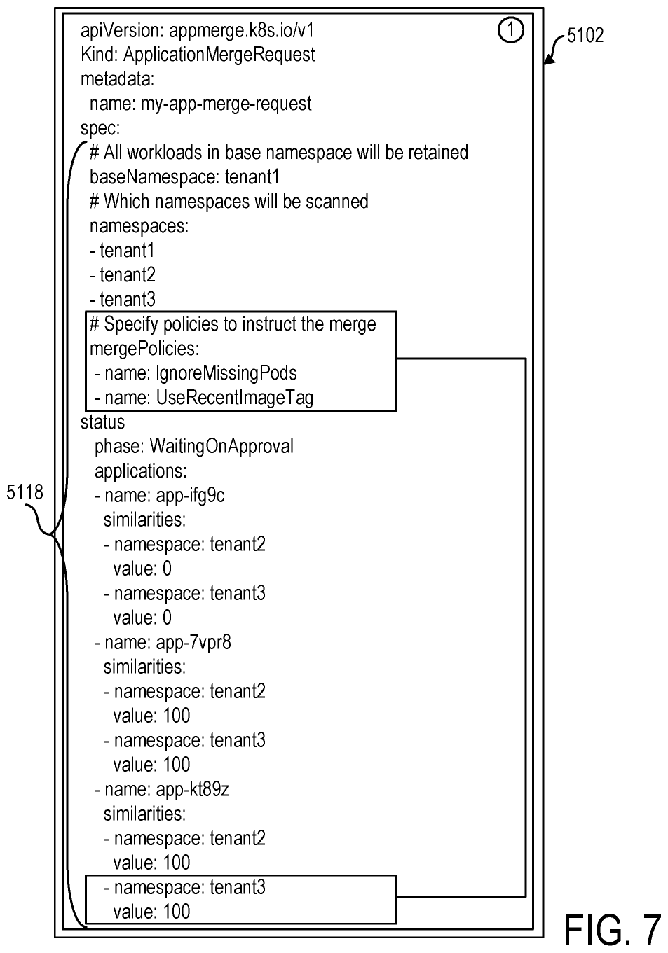

Cluster manager 110 can return different results as to whether workloads of different namespaces depending on which policy of policies are active. For example, in FIG. 7 there is shown prompting data 5118 that is similar to the prompting data 5118 of FIG. 6A except that a new workload group similarity level value is presented for the application defined by workload group app-kt89z. The new similarity level value has resulted from the additional policies being active as are specified within prompting data 5118.

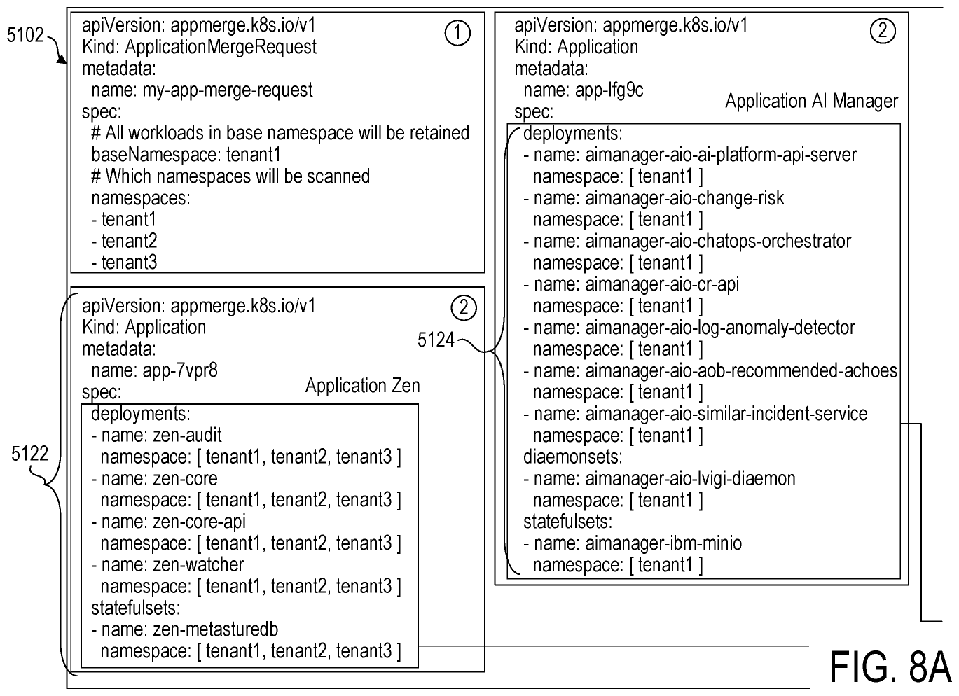

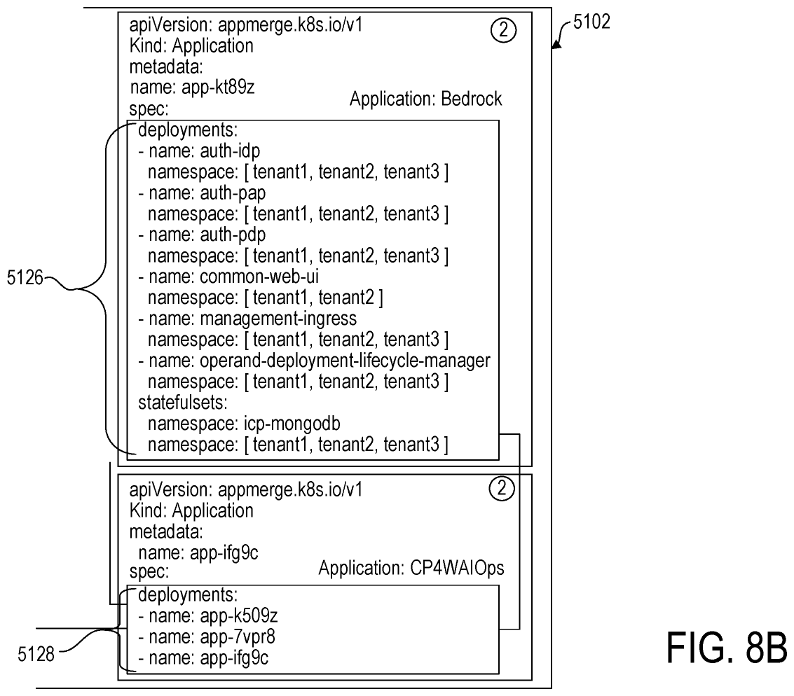

Further exemplary prompting data for prompting merging of workload groups is illustrated in FIGS. 8A-8B. Referring to FIG. 8A-8B, cluster manager 110 can present text based prompting data 5122, 5124, 5126, 5128 on UI 5102 that specifies the tenant associated namespaces to which various workload groups are included. Based on the prompting data presented in FIGS. 8A to 8B, it is seen from prompting data 5122 that all of the workload groups of the workload group app-7vpr8 are included in the namespaces associated to tenant1, tenant2, tenant3, and from prompting data 5126 that the workload group common-web-ui of the workload group app-kt89z is missing from the tenant3 namespace, and from prompting data 5124 that the workload group app-ifg9c is not included in the namespaces for tenant2 and tenant3. Thus, the described prompting data prompts for merging of the workload group app-7vpr8, and the workload group app-kt89z (with attention to the missing workload group missing from the tenant3 namespace).

In another aspect, prompting data generated at block 1112 can prompt a user to assign certain resources to merged workloads. As set forth in reference to Table H, cluster manager 110 at processing block 1111 can perform runtime analysis of workload groups that may be subject to merging. In another aspect, cluster manager 110 can ascertain resources for supporting merged workloads using one or more criterion as set forth in Table H.

TABLE H
For ascertaining resources, the cluster manager can apply:
${R}_{max} = {\sum }_{1}^{n} ( {\sum }_{1}^{r} {r}_{max} )$
Where Rₘₐₓ is the total max cpu or memory usage for a workload container across repli-
cas & namespaces within a time range.
For ascertaining resources, the cluster manager can apply:
$R min = {\sum }_{1}^{n} ( {\sum }_{1}^{r} r min )$
Where Rₘᵢₙ is the total min cpu or memory usage for a workload container across repli-
cas & namespaces within a time range.
Where rₘₐₓ is the max cpu or memory usage for a container of one workload of replicas
in a namespace within a time range.
Where rₘᵢₙ is the min cpu or memory usage for a container of one workload of replicas
in a namespace within a time range.
For ascertaining resources, the cluster manager can apply:
${r}^{′} limit = \frac{R max}{{r}^{′}} \\ {r}^{′} request = \frac{R min}{{r}^{′}}$
Where n is the number of namespaces.
Where r is the number of replicas in each namespace.
Where r′limit is the suggested cpu or memory limit for a workload container after merge
is done.
Where r′request is the suggested cpu or memory request for a workload container after
merge is done.
Where r′ is the number of replicas in the namespace after merge is done.

Based on the processing set forth in Table H, cluster manager 110 can generate for presentment prompting data at generating block 1112 that prompts for provisioning of workloads that are referenced in prompting data that prompts for merging of workloads. In reference to FIG. 9, prompting data 5142 of UI 5102 including prompting data within borders 5144 and 5146 prompts for resource provisioning for workloads that can be merged and have been identified as workloads suitable for merging. Accordingly, there is set forth herein, according to one embodiment, obtaining workload characterizing data, wherein the workload characterizing data characterizes a plurality of workloads of a cluster; assessing workloads of the plurality of workloads with use of characterizing data of the workload characterizing data; generating prompting data in dependence on the assessing of the workloads of the plurality of workloads, wherein the prompting data prompts for merging of identified workloads of the plurality of workloads; and presenting the prompting data to a user, wherein the method includes performing runtime workload analysis to determine a provisioning resource allocation for supporting a remaining workload subsequent to merger of the identified workloads, and wherein the prompting data references the provisioning resource allocation.

Accordingly, there is set forth herein, according to one embodiment, obtaining workload characterizing data, e.g., text based data and/or runtime metrics data, wherein the workload characterizing data characterizes a plurality of workloads of a cluster; assessing workloads of the plurality of workloads with use of characterizing data of the workload characterizing data; generating prompting data in dependence on the assessing of the workloads of the plurality of workloads, wherein the prompting data prompts for merging of identified workloads of the plurality of workloads; and presenting the prompting data to a user, wherein the assessing includes discovering workload groups comprising related workloads, and identifying, in dependence on the discovering, a first workload group of a first namespace and second workload group of a second namespace suitable for merging, wherein the prompting data, e.g., prompting data 5104, 5106, 5118, 5122, 5124, 5126, 5128 specifies a workload group name having a workload group instantiation in a first namespace defining the first workload group and a workload group instantiation in a second namespace defining the second workload group, and wherein the prompting data, e.g. prompting data 5104, 5106, 5118, further specifies a determined similarity level of the workload group instantiation in the first namespace defining the first workload group and the workload group instantiation in the second namespace defining the second workload group, wherein the assessing includes performing similarity analysis to obtain the determined similarity level of the workload group instantiation in the first namespace defining the first workload group and the workload group instantiation in the second namespace defining the second workload group, wherein the similarity analysis includes text based static analysis of the first workload group and the second workload group, e.g., including by processing text based data as set forth in Table A, and wherein the similarity analysis includes dynamic runtime analysis of the first workload group and the second workload group, e.g., as set forth in reference to Table D, wherein the method includes performing runtime workload analysis to determine a provisioning resource allocation, e.g., as set forth in reference to Table D and Table H, for supporting a remaining workload group subsequent to merger of the first workload group and the second workload group, and wherein the prompting data, e.g., prompting data 5142, references the provisioning resource allocation.

Based on the presentment of prompting data having the form of prompting data 5104, 5106, 5110, 5118, 5122, 5124, 5126, 5128, and/or 5142 the user can enter user defined input data using UI 5102. On receipt of the user defined data sent at block 1302, cluster manager 110 can proceed to block 1114.

At block 1114, cluster manager 110 can ascertain whether the user defined data has defined a request to perform reassessing of workloads within cluster 106 or whether a user has taken action to initiate merges of workloads. In determining that a user has defined a cluster reassessing request (e.g., by selection of a new policy), cluster manager 110 can return to a stage prior to block 1102 in order to initiate a subsequent discovery process on respective namespaces of cluster 106. Cluster manager 110 can iteratively perform the loop of blocks 1102 to 1114 for a time that user iterations of block 1102 sends user defined data specifying reassessing of cluster 106.

In such circumstances that user defined input data sent at block 1302 specifies initiation of merging of an application, cluster manager 110 at merge decision block 1114 can determine that a user has not requested reassessing of cluster workloads and can proceed to merge block 1115. Input data specifying initiating or merging can take on various forms. The user defined input data can include, e.g., edits to source code to resolve semantical conflicts between software files defining workloads groups, which edits can be prompted for with prompting data of the form described with reference to prompting data 5110 of FIG. 6B. The user defined input data can include, e.g., input data to assign appropriate resourcing to merged workloads as may be prompted for in a manner set forth in reference to Table H and FIG. 9.

At merge block 1115 in the described scenario, cluster manager 110 can ascertain based on the user defined data sent at block 1302 that the user has specified merging and can accordingly proceed to merge block 1116. At merge block 1116, cluster manager 110 can perform merging based on and in dependence on the user defined data input into UI 5102 and sent at block 1302. Merging can include removing a merged workload from one or more namespace of a cluster, where the workload has been identified as being suitable for merging. Cluster manager 110 can identify a certain workload as being suitable for merging by identifying a workload group that includes the certain workload as being suitable for merging. Embodiments herein can improve computing resource utilization by removing workloads of a cluster identified as being redundant to another workload or otherwise being unnecessary.

Embodiments herein can include the generation of prompting data that prompts a user to specify user defined data for use that specifies merging of applications and based on the user defined data, cluster manager 110 can perform application merges. Embodiments herein can include reduction of cluster footprints in more economized computing resource utilization. For example, certain workloads running on a cluster can be eliminated to reduce power consumption of an underlying computing node such as a hardware provided by a hardware computing node of a cluster.

For merging at block 1116 according to one illustrative embodiment, identify and access management (IAM) systems run by cluster manager 110 can be combined together to reduce the footprint and complexity for the platform. There can be performed auto-calculating and predicting the resources needed for the service instances to be merged at runtime to optimize the overall resource use after the service instances are merged. Depending on the service to be merged, service instances can be merged at runtime without the need of change at the code level or deployment level. The impact of a merge to dependent services can be transparent.

For facilitation of merging, a migration controller of cluster manager 110 can detect whether a set of service instances can be converged. Whether a set of service instances can be merged can be dependent on a version detect. A migration controller can qualify a merge if the version is the same or compatible. Whether versions are compatible can be based on checking of difference of application program interface (API) document or release notes. Services instances can be converged to a high version by default.

For ascertaining of CPU and memory resource requirements for supporting a merged workload, cluster manager 110 queries can be used for determining per-container, per-workload and per-node resource usage, per-workload memory usage in bytes. The following queries can be used: sum(container_memory_usage_bytes{container!=“ ”}) by (namespace,workload) Per-workload CPU usage in CPU cores: sum(rate(container cpu_usage_seconds_total{container!=“ ”}[5m])) by (namespace, workload). Particularizing resourcing of merged workloads can be prompted for in the manner described with reference to Table H and FIG. 9.

For calculating the CPU and memory of a migration instance based on the rules of convergence, a cluster manager 110 for large scale cluster footprint optimization, can analyze and can perform the converge run timely without requiring product development teams to change software code. For example, in the case of both CP4MCM and CP4WAIOPS, a lead operator can include built-in installation logic to launch a foundational service such that code changes are not needed if the foundational service exists. A migration controller can be configured to handle converge runs without code changes transparently.

Accordingly, there is set forth herein, according to one embodiment, obtaining workload characterizing data, e.g., text based data and/or runtime metrics data, wherein the workload characterizing data characterizes a plurality of workloads of a cluster; assessing workloads of the plurality of workloads with use of characterizing data of the workload characterizing data; generating prompting data in dependence on the assessing of the workloads of the plurality of workloads, wherein the prompting data prompts for merging of identified workloads of the plurality of workloads; and presenting the prompting data to a user, wherein the assessing includes discovering workload groups comprising related workloads, and identifying, in dependence on the discovering, a first workload group of a first namespace and second workload group of a second namespace suitable for merging, wherein the prompting data, e.g., prompting data 5104, 5106, 5118, 5122, 5124, 5126, 5128 specifies a workload group name having a workload group instantiation in a first namespace defining the first workload group and a workload group instantiation in a second namespace defining the second workload group, and wherein the prompting data, e.g. prompting data 5104, 5106, 5118, further specifies a determined similarity level of the workload group instantiation in the first namespace defining the first workload group and the workload group instantiation in the second namespace defining the second workload group, wherein the assessing includes performing similarity analysis to obtain the determined similarity level of the workload group instantiation in the first namespace defining the first workload group and the workload group instantiation in the second namespace defining the second workload group, wherein the similarity analysis includes one or more of the following selected from the group consisting of text based static analysis of the first workload group and the second workload group, e.g., including by processing text based data as set forth in Table A, and dynamic runtime analysis of the first workload group and the second workload group, e.g., as set forth in reference to Table D, wherein the method includes performing runtime workload analysis to determine a provisioning resource allocation, e.g., as set forth in reference to Table D and Table H, for supporting a remaining workload group subsequent to merger of the first workload group and the second workload group, wherein the prompting data, e.g., prompting data 5142, references the provisioning resource allocation, wherein the method includes merging the first workload group of the first namespace and the second workload group of the second namespace, wherein the merging includes removing the second workload group of the second namespace, wherein the merging is performed in dependence on user defined input data entered into a user interface, the user defined input data entered into a user interface responsively to the prompting data, e.g., prompting 5104, 5106, 5118, 5122, 5124, 5126, 5128, and/or 5142.

On completion of merge block 1116 cluster manager 110 can proceed to return block 1117. At return block 1117, cluster manager 110 can return to a stage preceding block 1101. Cluster manager 110 can iteratively perform the loop of blocks 1101-1117 for a deployment period of cluster manager 110. On completion of send block 1401, enterprise systems 140A-140Z can proceed to return block 1402. At return block 1402, enterprise systems 140A-140Z can return to a stage preceding block 1401. Enterprise systems 140A-140Z can iteratively perform the loop of blocks 1401-1402 for a deployment period of enterprise systems 140A-140Z. On completion of send block 1302, UE devices 130A-130Z can proceed to return block 1303. At return block 1303, UE devices 130A-130Z can return to a stage preceding block 1301. UE devices 130A-130Z can iteratively perform the loop of blocks 1301-1303 for a deployment period of UE devices 130A-130Z. On completion of decision block 1065, cluster 106 can proceed to return block 1066. At return block 1066, cluster 106 can return to a stage preceding block 1061. Cluster 106 can iteratively perform the loop of blocks 1061-1066 for a deployment period of cluster 106. On completion of send block 1501, clients 150A-150Z can proceed to return block 1502. At return block 1502, clients 150A-150Z can return to a stage preceding block 1501. Clients 150A-150Z can iteratively perform the loop of blocks 1501-1502 for a deployment period of clients 150A-150Z.

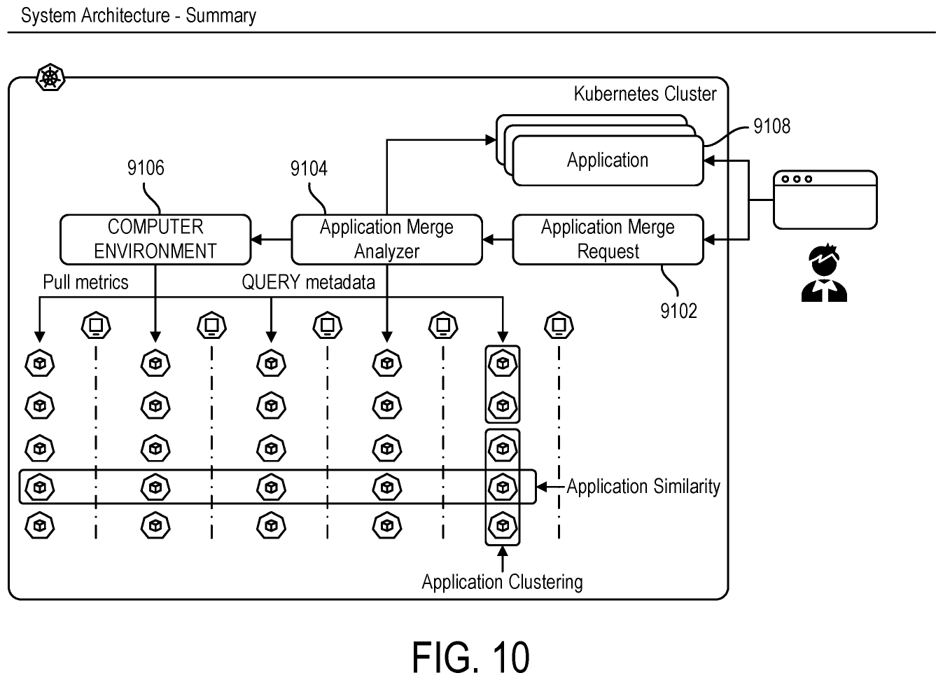

A system architecture for support of merge analysis and merging is set forth in reference to FIG. 10. A merge request 9102 can be received in response to user input data and sent to application merge analyzer 9104. The application merge analyzer 9104 communicates with command generator 9106 which generates commands to support merge analysis such as commands to support discovery processing and identification, in dependence on the discovery processing, of workloads suitable for merging. Based on analyzing, application merge analyzer 9104 can present prompting data that references a list of applications 9108 defined by workload groups to a user, and applications defined by workload groups can be merged based on input data entered by the user responsively to the prompting data.

Embodiments herein recognize that in a multi-tenancy cluster, each tenant can deploy their own applications into the cluster, and all applications can be isolated. Embodiments herein recognize that the isolated application might contain the same services, for example, the applications in tenant A and tenant B both include the same service, e.g., same IAM service or other type of service. Embodiments herein recognize that running multiple service instances for different tenants can increase both the footprint and the complexity of the cluster.

Embodiments herein can automatically discover duplicated applications defined by workload groups and can ascertain whether applications defined by workload groups are suitable for merging.

Embodiments herein can detect whether there are any duplicated application for each tenant that can be potentially merged. Embodiments herein can estimate the probability of merging duplicated applications and can provide, in the form of user interface presented prompting data, detailed information for each duplicated application in each tenant. During review, a user can optimize merges by adjusting the review results and see the impacts immediately. Presented review results can be sent to a user to take as reference for further action to support a merge, e.g.: change deployment or functional design and code. If the duplicated services for each tenant are merged, the merging can reduce both the footprint and the complexity of a cluster.

In the case of IAM services in one scenario, cluster manager 110 can present prompting data prompting for input entry so that one system uses one IAM that are shared by other components. In such a scenario, cluster manager 110 can merge all IAM instances together to reduce the footprint and complexity for the platform.

Cluster manager 110 can automatically discover new applications defined by workload groups by scanning workloads across namespaces and grouping related workloads together based on the calculation of workload distance. Cluster manager 110 can automatically calculate application similarity across namespaces by solving formulae with different factors considered to reflect different workload characteristics. Cluster manager 110 can automatically determine CPU and memory needs for the application to be merged at runtime to optimize the overall resource use after applications are merged. Cluster manager 110 can introduce a review process before merge happens so that a user can review the details with reasons for the application difference that is detected in each namespace and change the review results interactively by adjusting merge policies.

Cluster manager 110 can use hierarchically ordered workload groups to classify workloads from bottom to top to find applications defined by workload groups hierarchically. For a given set of workloads, cluster manager 110 can group workloads into workload groups so similar workloads in the clusters are close to each other. Cluster manager 110 can repeat workload group discovery until all workloads are grouped to a single workload group. Cluster manager 110 can build a workload group hierarchy. The workload group hierarchy can natively map to an application hierarchy where each workload group in the hierarchy maps to an application. Embodiments herein can provide rich and detailed analysis results in the form of prompting data that prompts for applications to be merged. The prompting data can guide users for any further action on system optimization at design, implementation, and deployment level.

Certain embodiments herein may offer various technical computing advantages involving computing advantages to address problems arising in the realm of computer systems and computer networks. Embodiments herein can reduce a footprint and resource utilization at a cluster based computer environment by assessing of workloads for merging. Assessing of a workload for merging can include a discovery process in which related workloads and workload groups are discovered, and an identifying process wherein workload groups and workloads suitable for merging are identified in dependence on the discovery process. Based on the discovery process and the identifying process prompting data can be generated and presented to a user. The prompting data can prompt for the merging of applications defined by workload groups for merging. The identifying process can utilize a hierarchical ordering of workload groups discovered by the discovering process, to facilitate the identification of a maximum number of workloads for merging and for reduction of computational resources associated to identification of workloads suitable for merging. In one embodiment, a cluster manager according to discovery processing can obtain text based data, e.g., text based markup language characterizing data of various workloads and based on analyzing of the text based markup language characterizing data can discover workloads and workload groups within a namespace that are related. The cluster manager further to the discovery processing can perform the described analyzing for each respective namespace within a cluster until workload group relationships are derived for all namespaces within a cluster. The cluster manager can then proceed to identifying processing for identifying workload groups suitable for merging. The cluster manager can identify workload groups suitable for merging in dependence on result data of the discovery processing. The identified workload groups suitable for merging can include workload groups of different namespaces. For identifying workload groups suitable for merging, the cluster manager can perform similarity analysis that includes processing of workload characterizing data, which characterizing data can include one or more of text based data and/or runtime performance metrics data. A cluster manager can generate prompting data in dependence on the identifying workload groups suitable for merging and in dependence on the discovery processing. The prompting data can prompt for merging of identified workloads, wherein the identified workloads have been identified as being suitable for merging. For enhancement of computational accuracies, embodiments can feature computational platforms existing only in the realm of computer networks such as artificial intelligence platforms, and machine learning platforms. Embodiments herein can employ data structuring processes, e.g., processing for transforming unstructured data into a form optimized for computerized processing. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

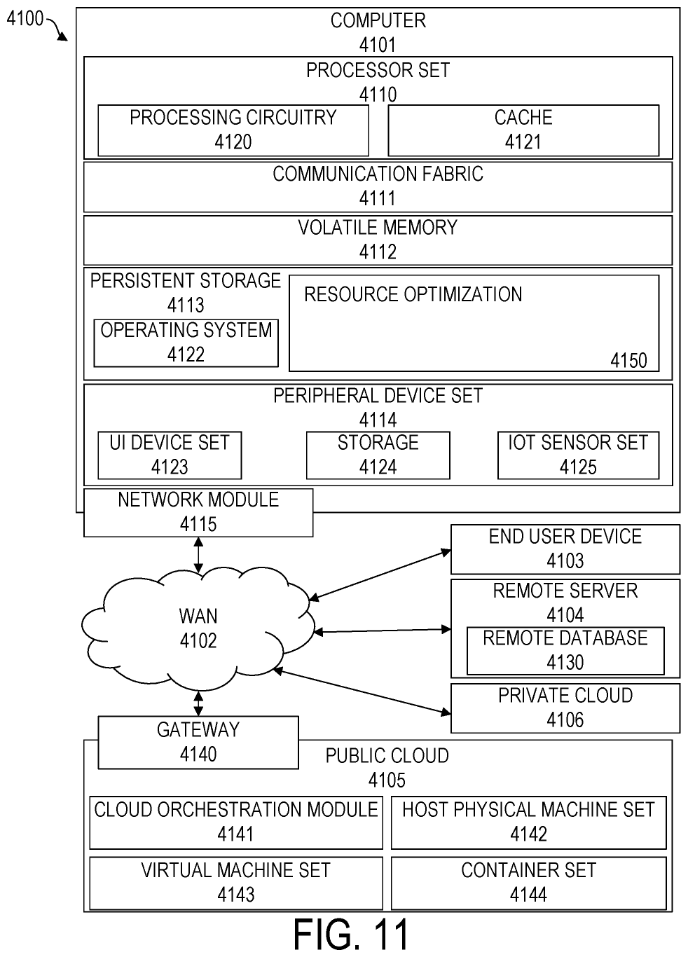

In reference to FIG. 11 there is set forth a description of a computing environment 4100 that can include one or more computer 4101. In one example, computing nodes 10A-10Z as set forth herein can be provided in accordance with computer 4101 as set forth in FIG. 11.

Various aspects of the present disclosure are described with reference to prophetic examples by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Hash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 11. In one aspect, a computing environment 4100 contains an example of an environment for the execution of at least some of the computer code involved in performing the inventive methods, such as code 4150 for performing resource optimization including by application merger analysis described with reference to FIGS. 1-10. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
obtaining workload characterizing data, wherein the workload characterizing data characterizes a plurality of workloads of a cluster;
assessing workloads of the plurality of workloads with use of characterizing data of the workload characterizing data;
generating prompting data in dependence on the assessing of the workloads of the plurality of workloads, wherein the prompting data prompts for merging of identified workloads of the plurality of workloads; and
presenting the prompting data to a user.

2. The computer implemented method of claim 1, wherein the assessing includes discovering relationships between workloads within a certain namespace of the cluster.

3. The computer implemented method of claim 1, wherein the assessing includes performing first intra-namespace analysis to discover relationships between workloads within a first namespace, performing second intra-namespace analysis to discover relationships between workloads within a second namespace, and identifying, in dependence on the first intra-namespace analysis and the second intra-namespace analysis that a first workload is suitable for merging with a second workload.

4. The computer implemented method of claim 1, wherein the assessing includes discovering related workloads within a first namespace, performing discovery of related workloads in a second namespace and identifying, in dependence on the discovering and the performing discovery, that a first workload is suitable for merging with a second workload, wherein the first workload is included in the first namespace, and wherein the second workload is included in the second namespace.

5. The computer implemented method of claim 1, wherein the assessing includes discovering a hierarchical ordering of workload groups within a first namespace, and identifying, in dependence on the hierarchical ordering of workload groups within a first namespace, that a first workload is suitable for merging with a second workload, wherein the first workload is included in the first namespace, and wherein the second workload is included in the second namespace.

6. The computer implemented method of claim 1, wherein the assessing includes discovering a hierarchical ordering of workload groups within a first namespace, discovering a hierarchical ordering of workload groups within a second namespace and identifying, in dependence on the hierarchical ordering of workload groups within the first namespace and in dependence on the hierarchical ordering of workload groups within the second namespace, that a first workload is suitable for merging with a second workload, wherein the first workload is included in the first namespace, and wherein the second workload is included in the second namespace.

7. The computer implemented method of claim 1, wherein the assessing includes discovering workload groups comprising related workloads, and identifying, in dependence on the discovering, first and second workload groups suitable for merging.

8. The computer implemented method of claim 1, wherein the assessing includes discovering workload groups comprising related workloads, and identifying, in dependence on the discovering, first and second workload groups suitable for merging, wherein the prompting data references the first and second workload groups.

9. The computer implemented method of claim 1, wherein the assessing includes discovering a hierarchical ordering of workload groups within a first namespace, discovering a hierarchical ordering of workload groups within a second namespace and identifying, in dependence on the hierarchical ordering of workload groups within the first namespace and in dependence on the hierarchical ordering of workload groups within the second namespace, a first workload suitable for merging with a second workload, wherein the first workload is included in the first namespace, and wherein the second workload is included in the second namespace, wherein the prompting data prompts for merging of the first and second workloads.

10. The computer implemented method of claim 1, wherein the method includes performing runtime workload analysis to determine a provisioning resource allocation for supporting a remaining workload subsequent to merger of the identified workloads, and wherein the prompting data references the provisioning resource allocation.

11. The computer implemented method of claim 1, wherein the assessing includes discovering relationships between workloads within a certain namespace of the cluster, wherein the discovering includes processing text based reports for respective workloads of the certain namespace, and wherein the discovering includes ascertaining, in dependence on the processing text based reports for respective workloads of the certain namespace Euclidean distances between the respective workloads of the certain namespace.

12. The computer implemented method of claim 1, wherein the prompting data specifies a workload group name having a workload group instantiation in a first namespace and a workload group instantiation in a second namespace, and further specifies a determined similarity level of the workload group instantiation in the first namespace and the workload group instantiation in the second namespace.

13. The computer implemented method of claim 1, wherein the assessing includes discovering workload groups comprising related workloads, and identifying, in dependence on the discovering, a first workload group of a first namespace and second workload group of a second namespace suitable for merging, wherein the prompting data specifies a workload group name having a workload group instantiation in a first namespace defining the first workload group and a workload group instantiation in a second namespace defining the second workload group, and wherein the prompting data further specifies a determined similarity level of the workload group instantiation in the first namespace defining the first workload group and the workload group instantiation in the second namespace defining the second workload group, wherein the assessing includes performing similarity analysis to obtain the determined similarity level of the workload group instantiation in the first namespace defining the first workload group and the workload group instantiation in the second namespace defining the second workload group, wherein the similarity analysis includes text based static analysis of the first workload group and the second workload group, and wherein the similarity analysis includes dynamic runtime analysis of the first workload group and the second workload group.

14. The computer implemented method of claim 1, wherein the assessing includes discovering workload groups comprising related workloads, and identifying, in dependence on the discovering, a first workload group of a first namespace and second workload group of a second namespace suitable for merging, wherein the prompting data specifies a workload group name having a workload group instantiation in a first namespace defining the first workload group and a workload group instantiation in a second namespace defining the second workload group, and wherein the prompting data further specifies a determined similarity level of the workload group instantiation in the first namespace defining the first workload group and the workload group instantiation in the second namespace defining the second workload group, wherein the assessing includes performing similarity analysis to obtain the determined similarity level of the workload group instantiation in the first namespace defining the first workload group and the workload group instantiation in the second namespace defining the second workload group, wherein the similarity analysis includes text based static analysis of the first workload group and the second workload group, and wherein the similarity analysis includes dynamic runtime analysis of the first workload group and the second workload group, wherein the method includes performing runtime workload analysis to determine a provisioning resource allocation for supporting a remaining workload group subsequent to merger of the first workload group and the second workload group, and wherein the prompting data references the provisioning resource allocation.

15. The computer implemented method of claim 1, wherein the workload characterizing data of the plurality of workloads of a cluster includes one or more text based data or runtime metrics data.

16. The computer implemented method of claim 1, wherein the prompting data specifies the identified workloads.

17. The computer implemented method of claim 1, wherein the assessing includes discovering workload groups comprising related workloads, and identifying, in dependence on the discovering, a first workload group of a first namespace and second workload group of a second namespace suitable for merging, wherein the method includes merging the first workload group of the first namespace and the second workload group of the second namespace, wherein the merging includes removing the second workload group of the second namespace.

18. The computer implemented method of claim 1, wherein the assessing includes discovering workload groups comprising related workloads, and identifying, in dependence on the discovering, a first workload group of a first namespace and second workload group of a second namespace suitable for merging, wherein the method includes merging the first workload group of the first namespace and the second workload group of the second namespace, wherein the merging includes removing the second workload group of the second namespace, wherein the merging is performed in dependence on user defined input data entered into a user interface, the user defined input data entered into a user interface responsively to the prompting data.

19. A system comprising:
a memory;
at least one processor in communication with the memory; and
program instructions executable by one or more processor via the memory to perform a method comprising:
obtaining workload characterizing data, wherein the workload characterizing data characterizes a plurality of workloads of a cluster;
assessing workloads of the plurality of workloads with use of characterizing data of the workload characterizing data;
generating prompting data in dependence on the assessing of the workloads of the plurality of workloads, wherein the prompting data prompts for merging of identified workloads of the plurality of workloads; and
presenting the prompting data to a user.

20. A computer program product comprising:
a computer readable storage medium readable by one or more processing circuit and storing instructions for execution by one or more processor for performing a method comprising:
obtaining workload characterizing data, wherein the workload characterizing data characterizes a plurality of workloads of a cluster;
assessing workloads of the plurality of workloads with use of characterizing data of the workload characterizing data;
generating prompting data in dependence on the assessing of the workloads of the plurality of workloads, wherein the prompting data prompts for merging of identified workloads of the plurality of workloads; and
presenting the prompting data to a user.
